(19) United States
(12) Patent Application Publication
(10) Pub. No.: US 2026/0358070 A1
(43) Pub. Date: Nov. 12, 2026

(54) THERMALLY CONDUCTIVE SHEET AND METHOD FOR PRODUCING SAME

(71) Applicant: KANEKA CORPORATION, Osaka (JP)

(72) Inventor: Yasushi NISHIKAWA, Osaka (JP)

(73) Assignee: KANEKA CORPORATION, Osaka (JP)

(21) Appl. No.: 19/247,841

(22) Filed: Jun. 24, 2025

(30) Foreign Application Priority Data
Aug. 8, 2024 (JP) 2024-133325

(51) Int. Cl. F28F 21/02; C09K 5/14

(52) U.S. Cl. CPC F28F 21/02; C09K 5/14

(57) ABSTRACT

Provided is a thermally conductive sheet that has a low thermal resistance value, excellent tackiness, excellent initial adhesion, excellent adhesion after high temperature holding, and excellent adhesion after a heat cycle. A thermally conductive sheet in accordance with the present disclosure includes, on a surface thereof, a first area measuring 500 μm×50 μm and a second area measuring 500 μm×50 μm, and an atomic concentration (a2) of carbon atoms contained in the second area is higher than an atomic concentration (a1) of carbon atoms contained in the first area.

This Nonprovisional application claims priority under 35 U.S.C. § 119 on Patent Application No. 2024-133325 filed in Japan on Aug. 8, 2024, the entire contents of which are hereby incorporated by reference.

### TECHNICAL FIELD

The present invention relates to a thermally conductive sheet and a method for producing the same.

### BACKGROUND ART

A technique for inhibiting temperature increases by attaching a heat-dissipating body to a heat-generating body such as an electronic component is conventionally known. In a case where this heat-dissipating body is used, a member that is in sheet form and that has thermal conductivity (thermally conductive sheet) is used to efficiently transmit heat from the heat-generating body to the heat-dissipating body. Further, the thermally conductive sheet is required to also have adhesion to an adherend.

A thermally conductive sheet containing a composition containing graphite particles and an organic polymer compound, the graphite particles being oriented in a thickness direction of the thermally conductive sheet, is known as a thermally conductive sheet that has thermal conductivity and adhesion to an adherend (see, for example, Patent Literatures 1 and 2).

### CITATION LIST

### Patent Literature

[Patent Literature 1]
Pamphlet of International Publication No. WO 2008/053843
[Patent Literature 2]
Japanese Patent Application Publication, Tokukai, No. 2017-141443

### SUMMARY OF INVENTION

### Technical Problem

The thermally conductive sheets described in Patent Literatures 1 and 2 have a certain level of thermal conductivity and a certain level of adhesion. In recent years, high-performance CPUs and GPUs and the like are used in, for example, a server, a supercomputer, and an electronic control unit (ECU) in an automobile. With increase in volume of information processing, increase in processing speed, and the like, the temperature of a chip tends to increase. Since an increase in temperature of a chip causes a decrease in performance of CPUs, GPUs, etc., it is necessary to dissipate heat more efficiently even in a high temperature environment. In order to accommodate such applications, a thermally conductive sheet that has much lower thermal resistance than conventional thermally conductive sheets is required. In addition, in order to increase adhesion to an adherend, a thermally conductive sheet is required to be less likely to be detached when the thermally conductive sheet is temporarily attached to the adherend. Further, there is a case in which the thermally conductive sheet may be held in a high temperature environment while adhering to an adherend or may be held in a state in which a change in temperature between low temperature and high temperature is repeated, while adhering to an adherend. Thus, the thermally conductive sheet is also required to have excellent adhesion after high temperature holding and excellent adhesion after a heat cycle, in addition to initial adhesion to an adherend.

Thus, an aspect of the present invention has an object to provide a thermally conductive sheet that has a low thermal resistance value, excellent tackiness, excellent initial adhesion, excellent adhesion after high temperature holding, and excellent adhesion after a heat cycle.

### Solution to Problem

In order to attain the object, a thermally conductive sheet in accordance with an embodiment of the present invention is a thermally conductive sheet that includes a composition containing graphite particles (A) and an organic polymer compound (B), the graphite particles (A) being oriented in a thickness direction of the thermally conductive sheet, wherein when a first area measuring 500 μm×50 μm and a second area measuring 500 μm×50 μm are set on a surface of the thermally conductive sheet, at least one set of the first area and the second area satisfies a relationship such that the following (a2) is higher than the following (a1):
(a1) an atomic concentration of carbon atoms contained in the first area; and
(a2) an atomic concentration of carbon atoms contained in the second area.

In order to attain the object, a method for producing a thermally conductive sheet in accordance with an embodiment of the present invention includes: a primary sheet forming step of forming, in sheet form, a mixture containing graphite particles (A), an organic polymer compound (B), and a solvent to obtain a primary sheet; a laminate forming step of laminating the primary sheet to obtain a primary sheet laminate; and a slicing step of slicing a laminate cross section of the primary sheet laminate to obtain a thermally conductive sheet.

### Advantageous Effects of Invention

An aspect of the present invention makes it possible to provide a thermally conductive sheet that has a low thermal resistance value, excellent tackiness, excellent initial adhesion, excellent adhesion after high temperature holding, and excellent adhesion after a heat cycle. Thus, the thermally conductive sheet is also preferably applied to applications where it is necessary to efficiently dissipate heat.

### BRIEF DESCRIPTION OF DRAWINGS

FIG. 1 is a view showing the results obtained by subjecting a surface of a thermally conductive sheet obtained in Example 1 to SEM-EDX and mapping. 1001 indicates the result of identification of carbon, and 1002 is an SEM image of the surface.

FIG. 2 is an enlarged view of 1002 in FIG. 1 and is a view showing states of an area measuring 500 μm×50 μm (area 1) and an area measuring 500 μm×50 μm (area 2) which are set on the surface of the thermally conductive sheet.

FIG. 3 is a view showing the results obtained by subjecting a surface of a thermally conductive sheet obtained in Example 3 to SEM-EDX and mapping. 1003 indicates the result of identification of carbon, and 1004 is an SEM image of the surface.

FIG. 4 is a view showing states of an area measuring 500 μm×50 μm (area 1) and an area measuring 500 μm×50 μm (area 2) which are set on the surface of the thermally conductive sheet obtained in Example 3.

FIG. 5 is a view showing the results obtained by subjecting a surface of a thermally conductive sheet in accordance with Comparative Example 1 to SEM-EDX and mapping. 1005 indicates the result of identification of carbon, and 1006 is an SEM image of the surface.

FIG. 6 is an enlarged view of 1006 in FIG. 5 and shows states of areas 1 and 2 which are set respectively at positions substantially corresponding to the areas 1 and 2 shown in FIG. 2.

### DESCRIPTION OF EMBODIMENTS

The following description will discuss embodiments of the present invention. The present invention is not, however, limited to these embodiments. The present invention is not limited to the configurations described below, but may be altered in various ways within the scope of the claims. The present invention also encompasses, in its technical scope, any embodiment or example derived by combining technical means disclosed in differing embodiments or examples. Further, it is possible to form a new technical feature by combining the technical means disclosed in the respective embodiments. Note that all academic documents and patent literatures cited herein are incorporated herein by reference. Any numerical range expressed as “A to B” herein means “not less than A and not more than B (i.e., a range from A to B which includes both A and B)” unless otherwise stated.

### [1. Thermally Conductive Sheet]

A thermally conductive sheet in accordance with an embodiment of the present invention is a thermally conductive sheet that contains a composition containing graphite particles (A) and an organic polymer compound (B), the graphite particles (A) being oriented in a thickness direction of the thermally conductive sheet, wherein when a first area measuring 500 μm×50 μm and a second area measuring 500 μm×50 μm are set on a surface of thermally conductive sheet, at least one set of the first area and the second area satisfies a relationship such that the following (a2) is higher than the following (a1):
(a1) an atomic concentration of carbon atoms contained in the first area; and
(a2) an atomic concentration of carbon atoms contained in the second area.

The inventor of the present invention set, as an area measuring 500 μm×50 μm, a first area and a second area on a surface of a thermally conductive sheet and carried out elemental analysis with an energy-dispersive X-ray analyzer (SEM-EDX) attached to a scanning electron microscope (SEM). As a result, on a surface of a thermally conductive sheet in accordance with an embodiment of the present invention (hereinafter also referred to as a thermally conductive sheet of an aspect of the present invention), there existed a first area having a low atomic concentration of carbon atoms and a second area having a higher atomic concentration of carbon atoms than the first area. On the other hand, in the conventionally known thermally conductive sheet, no matter how the first area and the second area were set, no bias of the atomic concentration of carbon atoms was found in the first area and the second area. Then, the inventor of the present invention found that the thermally conductive sheet of an aspect of the present invention has a lower thermal resistance value, more excellent tackiness, more excellent initial adhesion, more excellent adhesion after high temperature holding, and more excellent adhesion after a heat cycle than the conventionally known thermally conductive sheet, and completed the present invention.

The first area and the second area can be set, for example, under observation of a surface of the thermally conductive sheet of an aspect of the present invention with use of an SEM. An area having a higher atomic concentration of carbon atoms is regarded as the second area, and an area having a lower atomic concentration of carbon atoms is regarded as the first area. The thermally conductive sheet of an aspect of the present invention only needs to have at least one set of a first area and a second area that satisfy a relationship such that the (a2) is higher than the (a1). For example, assume that there is a case where two areas each measuring 500 μm×50 μm which are set under observation of the surface of the thermally conductive sheet cannot satisfy the requirement that the (a2) be higher than the (a1). Even in this case, for example, when another two areas each measuring 500 μm×50 μm which are set on the surface of the thermally conductive sheet satisfy the above-described requirement, the thermally conductive sheet falls under the thermally conductive sheet of an aspect of the present invention.

Further, the first area and the second area are not limited to one set. For example, in a case where a first area and a second area set on the surface of the thermally conductive sheet satisfy the above-described requirement, another two areas each measuring 500 μm×50 μm which are set so as to be areas differing from the first area and the second area may also satisfy the above-described requirement.

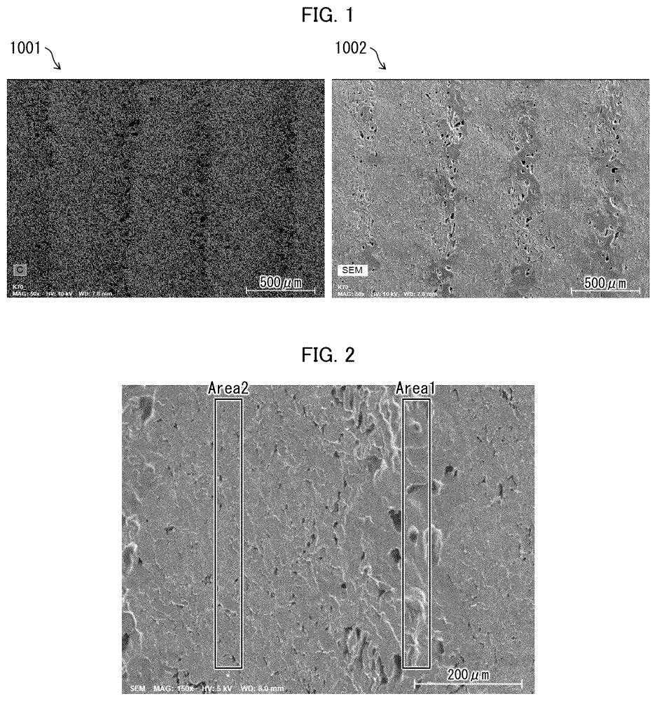

The first area and the second area that satisfy the above-described requirement can be determined on the basis of, for example, a difference in outer appearance that is found when the surface is observed with an SEM. The following will discuss this point with reference to FIGS. 1 to 6.

FIG. 1 is a view showing the results obtained by subjecting a surface of a thermally conductive sheet obtained in Example 1, which will be described later, to SEM-EDX and mapping. 1001 indicates the result of identification of carbon, and 1002 is an SEM image of the surface.

In 1001 and 1002, four vertical regions appearing darker than their surroundings and being spaced at substantially equal intervals are observed. Although the state of the surface of the thermally conductive sheet of an aspect of the present invention is not limited to that shown in FIG. 1, the thermally conductive sheet of an aspect of the present invention includes a region that is clearly distinguishable in outer appearance from other regions, as shown in, for example, 1001 and 1002. The elemental analysis by the inventor of the present invention revealed that the regions other than the regions appearing darker than their surroundings, shown in 1001 and 1002, have a high atomic concentration of carbon atoms and that the regions appearing darker than their surroundings have a low atomic concentration of carbon atoms.

FIG. 2 is an enlarged view of 1002 in FIG. 1. As shown in FIG. 2, the surface of the thermally conductive sheet is observed by an SEM, a first area measuring 500 μm×50 μm is set, and a second area measuring 500 μm×50 μm is set. In this case, for example, by SEM-EDX, it is possible to confirm that the (a2) is higher than the (a1). “Area 1” illustrated in FIG. 2 corresponds to the first area, and “Area 2” illustrated in FIG. 2 corresponds to the second area.

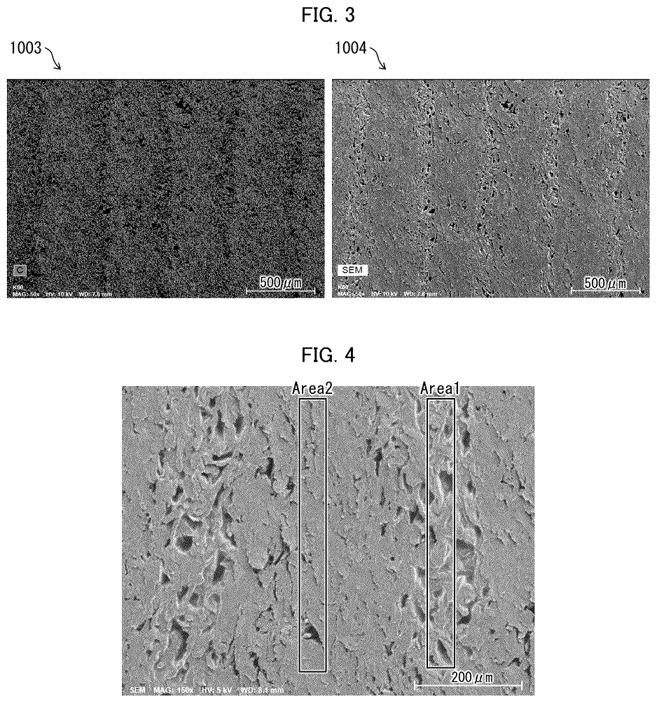

FIG. 3 is a view showing the results obtained by subjecting a surface of a thermally conductive sheet obtained in Example 3, which will be described later, to SEM-EDX and mapping. 1003 indicates the result of identification of carbon, and 1004 is an SEM image of the surface. FIG. 4 is an enlarged view of 1004 in FIG. 3 and is a view showing states of an area measuring 500 μm×50 μm (area 1) and an area measuring 500 μm×50 μm (area 2) which are set on the surface of the thermally conductive sheet. In this case, similarly to FIGS. 1 and 2, regions appearing darker than their surroundings were observed in 1003 and 1004, and regions other than the regions appearing darker than their surroundings had a high atomic concentration of carbon atoms, and the regions appearing darker than their surroundings had a low atomic concentration of carbon atoms. Thus, for example, by setting the first area and the second area as shown in FIG. 4, it is possible to confirm that the (a2) is higher than the (a1).

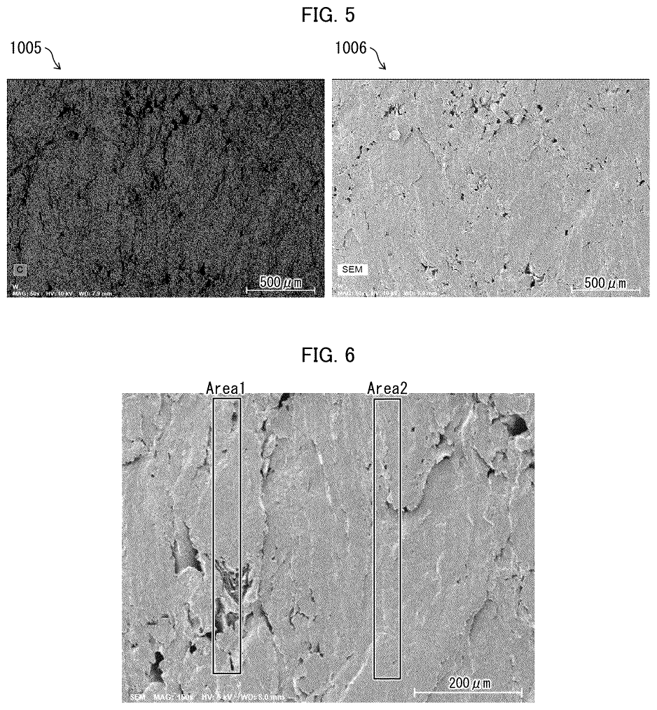

Meanwhile, FIG. 5 is a view showing the results obtained by subjecting a surface of a thermally conductive sheet obtained in Comparative Example 1, which will be described later, to SEM-EDX and mapping. 1005 indicates the result of identification of carbon, and 1006 is an SEM image of the surface. FIG. 6 is an enlarged view of 1006 in FIG. 5 and shows states of areas 1 and 2 which are set respectively at positions substantially corresponding to the areas 1 and 2 shown in FIG. 2. In this case, as shown in FIGS. 5 and 6, the regions appearing darker than their surroundings as seen in FIG. 1 and other drawings were not observed at all. In addition, no matter how the first area and the second area were set, it could not be confirmed that the (a2) was higher than the (a1).

The reason for setting the first area and the second area to be each 500 μm in length and 50 μm in width is that setting the first area and the second area to be excessively large areas results in difficulty in setting areas that satisfy the requirement that “the (a2) be higher than the (a1)”.

The more regions appearing darker than their surroundings the first area contains therewithin, the more preferable the first area is. The first area most preferably contains only the regions appearing darker than their surroundings. Conversely, the lower the proportion of the regions appearing darker than their surroundings, the more preferable the second area is. The second area most preferably does not contain the regions appearing darker than their surroundings at all. This is because the more the regions appearing darker than their surroundings the first area contains, the more easily the thermally conductive sheet satisfies the requirement that “the (a2) be higher than the (a1)” and brings about the effects described above.

Thus, the thermally conductive sheet of an aspect of the present invention has a difference in atomic concentration of carbon atoms between the first area and the second area. The inventor of the present invention found that one thermally conductive sheet, by having the first area and the second area, exhibits an extremely excellent thermal resistance value, extremely excellent tackiness, extremely excellent initial adhesion, extremely excellent adhesion after high temperature holding, and extremely excellent adhesion after a heat cycle.

The second area has a higher atomic concentration of carbon atoms than the first area. This is considered to be due to the presence of more graphite particles (A) in the second area than in the first area. Thus, it is considered that the second area primarily contributes to lowering of the thermal resistance value derived from the graphite particles (A) and tackiness (decrease in tackiness).

Meanwhile, it has been found by the inventor of the present invention that the first area has a lower atomic concentration of carbon atoms than the second area and has a higher atomic concentration of oxygen atoms than the second area. In other words, it is considered that the first area is an area which contains many oxygen atoms derived from the organic polymer compound (B). Thus, it is considered that the first area primarily contributes to the exhibition of tackiness derived from the organic polymer compound (B) (increase in tackiness), initial adhesion, adhesion after high temperature holding, and adhesion after a heat cycle.

Note that the fact that the second area has a higher atomic concentration of carbon atom than the first area and the fact that the first area has a higher atomic concentration of oxygen atom than the second area can be confirmed by, for example, mapping analysis using SEM-EDX.

Thus, a thermally conductive sheet in accordance with an embodiment of the present invention has an area that primarily contributes to lowering of the thermal resistance value and an area that primarily contributes to the exhibition of tackiness, initial adhesion, adhesion after high temperature holding, and adhesion after a heat cycle. Therefore, it is considered that the thermally conductive sheet in accordance with an embodiment of the present invention can clearly exhibit a low thermal resistance value and clearly exhibit tackiness, initial adhesion, adhesion after high temperature holding, and adhesion after a heat cycle, independently of a low thermal resistance value, although a detailed reason is unclear. Specifically, the thermally conductive sheet can bring about, for example, the following effects (a) to (d).

(a) The thermally conductive sheet of an aspect of the present invention can lower the thermal resistance value by the presence of the second area.

(b) The thermally conductive sheet of an aspect of the present invention is easy to peel off from a mount due to the presence of the first area.

(c) The thermally conductive sheet of an aspect of the present invention is easy to temporarily bond to a heat-generating body due to the presence of the first area.

(d) The thermally conductive sheet of an aspect of the present invention has excellent initial adhesion when heated and bonded to a heat-generating body and a heat dissipator, excellent adhesion after high temperature holding, and excellent adhesion after a heat cycle, due to the presence of the first area. Thus, it is possible to effectively transport, to the heat dissipator, heat derived from the heat-generating body.

Examples of a method for producing a thermally conductive sheet of an aspect of the present invention include a method for producing a thermally conductive sheet in accordance with an embodiment of the present invention, which will be described later.

The thermally conductive sheet of an aspect of the present invention is preferably such that a value obtained by dividing the (a2) by the (a1) is not less than 1.01.

In the thermally conductive sheet having such a configuration, the above-described value is not less than 1.01. Thus, it is clearer that more graphite particles (A) are present in the second area than in the first area. Therefore, it is possible to bring about the above-described effects (a) to (d) more efficiently. From such a viewpoint, the above-described value is more preferably not less than 1.05, and even more preferably not less than 1.07.

Meanwhile, the presence of a plurality of areas with extremely different compositions in one thermally conductive sheet may cause inconveniences such as differences in, for example, hardness of the thermally conductive sheet among different areas. Thus, an upper limit of the value obtained by dividing the (a2) by the (a1) is preferably not more than 2.0, more preferably not more than 1.8, and even more preferably not more than 1.5.

A specific numerical value of the atomic concentration can be determined by performing area analysis of the first area and the second area by SEM-EDX and performing semi-quantitation by a ZAF method. Specific analysis conditions will be described later in Examples. Then, by determining a value obtained by dividing the atomic concentration (a2) of carbon atoms contained in the second area by the atomic concentration (a1) of carbon atoms contained in the first area, it can be confirmed that the value is not less than 1.01.

Examples of a method for producing a thermally conductive sheet such that the above-described value is not less than 1.01 include a method for producing a thermally conductive sheet in accordance with an embodiment of the present invention, which will be described later.

The thermally conductive sheet of an aspect of the present invention is preferably such that a difference between the (a2) and the (a1) is not less than 1% by atom.

In the thermally conductive sheet having such a configuration, the above-described difference is not less than 1% by atom. Thus, it is clearer that more graphite particles (A) are present in the second area than in the first area. Therefore, it is possible to bring about the above-described effects (a) to (d) more efficiently. From such a viewpoint, the above-described difference is more preferably not less than 2% by atom, more preferably not less than 3% by atom, even more preferably not less than 5% by atom, and particularly preferably not less than 7% by atom.

Meanwhile, the presence of a plurality of areas with extremely different compositions in one thermally conductive sheet may cause inconveniences such as differences in, for example, hardness of the thermally conductive sheet among different areas. Thus, the above-described difference is preferably not more than 30% by atom, more preferably not more than 25% by atom, and even more preferably not more than 20% by atom.

The above-described difference can be determined by performing area analysis of the first area and the second area by SEM-EDX, performing semi-quantitation by a ZAF method to obtain the atomic concentrations of carbon atoms, and subtracting the (a1) from the (a2).

The value of the atomic concentration (a1) of carbon atoms contained in the first area is preferably 60% by atom to 98% by atom, and more preferably 65% by atom to 97% by atom, because it is possible to lower the thermal resistance value.

The value of the atomic concentration (a2) of carbon atoms contained in the second area is preferably 65% by atom to 99% by atom, and more preferably 70% by atom to 98% by atom, because it is possible to improve tackiness, adhesion, adhesion after high temperature holding, and adhesion after a heat cycle.

Examples of a method for producing a thermally conductive sheet such that the above-described difference is not less than 1% by atom include a method for producing a thermally conductive sheet in accordance with an embodiment of the present invention, which will be described later.

The thermally conductive sheet of an aspect of the present invention is preferably such that the (a2) is measured in one strip among strips constituting the thermally conductive sheet, and the (a1) is measured in an area between the one strip and another strip which is adjacent to the one strip.

As described later, the thermally conductive sheet can be obtained by slicing a laminate cross section of a primary sheet laminate. Thus, in the thermally conductive sheet, there is an interface between one primary sheet that is a component of the thermally conductive sheet and another primary sheet that is adjacent to the one primary sheet. Further, the aforementioned region appearing darker than its surroundings is formed at the periphery of the interface.

Note here that primary sheets constituting the thermally conductive sheet are referred to as “strips”. The above-described one strip can be arbitrarily selected from among the strips constituting the thermally conductive sheet. The (a2) is measured in the selected one strip. The second area in which the (a2) is measured is preferably set so as not to include the region appearing darker than its surroundings, as mentioned earlier. Thus, the second area only needs to be set in such a manner.

On the other hand, the first area is preferably set so as to include more regions appearing darker than their surroundings, as mentioned earlier. The region appearing darker than its surroundings is formed at the periphery of the above-described interface. Thus, setting the first area in an area between the one strip and another strip which is adjacent to the one strip makes it possible to set the first area that includes the region appearing darker than its surroundings, more reliably than setting the first area only in one strip. Therefore, it is possible to easily confirm that the thermally conductive sheet satisfies the requirement that “the (a2) be higher than the (a1)”.

The thermally conductive sheet is a thermally conductive sheet that contains a composition containing graphite particles (A) and an organic polymer compound (B), and is preferably such that the graphite particles (A) are oriented in a thickness direction of the thermally conductive sheet.

### (Graphite Particles (A))

The thermally conductive sheet containing the graphite particles (A) allows the graphite particles (A) that have thermal conductivity to be dispersed in the thermally conductive sheet. Thus, the thermally conductive sheet can have higher thermal conductivity. This makes it possible to reduce thermal resistance of the thermally conductive sheet.

The graphite particles (A) may have a shape that is either spherical or non-spherical. From the viewpoint that the graphite particles (A) being easily oriented makes it possible to improve thermal conductivity in an orientation direction in which the graphite particles (A) are oriented, so that thermal resistance in the orientation direction can be reduced, the thermally conductive sheet preferably contains the graphite particles (A) having a non-spherical shape. Note that only one type of graphite particles (A) may be used, or two or more types of graphite particles (A) may be used in combination.

The graphite particles (A) having a non-spherical shape have a shape that is not particularly limited. For example, the shape can be a plate-like shape such as a scale-like shape or a flaky shape; a spheroidal shape; a needle shape; a rod shape; a fibrous shape; or an irregular shape. Among these, the shape of the graphite particles (A) having a non-spherical shape is more preferably a plate-like shape such as a scale-like shape or a flaky shape from the viewpoint that, in a case where the graphite particles (A) having a non-spherical shape have the plate-like shape, the graphite particles (A) are easily oriented and easily maintain a contact between the particles, and thus make it possible to further improve thermal conductivity in the orientation direction, so that thermal resistance in the orientation direction can be further reduced.

In the present specification, “spherical shape” means a perfect spherical shape or a spheroidal shape having an aspect ratio of 1.0 to 1.5, in other words, a perfect spherical shape having an aspect ratio of 1.0 or a spheroidal shape having an aspect ratio of more than 1.0 and not more than 1.5, and does not necessarily need to be a perfect spherical shape. Note that the aspect ratio in a case where the graphite particles (A) have a “spherical shape” means a ratio represented by the major axis/the minor axis. Further, “non-spherical shape” means a shape different from the “spherical shape”, i.e., a shape having an aspect ratio of more than 1.5. Note that “spheroidal shape” means an ellipsoidal shape obtained by rotating an ellipse, such as a rugby ball.

In the graphite particles (A) having a “non-spherical shape”, the aspect ratio means a ratio of a maximum length to a minimum length (maximum length/minimum length) of the graphite particles (A). For example, in a case where the shape is a plate-like shape, the aspect ratio is a ratio of the maximum length to a thickness (maximum length/thickness) of the graphite particles (A). The aspect ratio can be determined as follows. Specifically, a sufficient number of (e.g., not less than 10) graphite particles (A) are observed with a scanning electron microscope, the major axis/the minor axis or the maximum length/the minimum length of each of the graphite particles (A) is calculated, and the aspect ratio is determined as an average of the calculated major axis/minor axis or the calculated maximum length/minimum length.

In a case where two or more types of graphite particles (A) are used, the aspect ratio is an average aspect ratio calculated by performing weighted average calculation on aspect ratios of the respective types of graphite particles (A).

The aspect ratio of the graphite particles (A) is preferably not less than 20, more preferably not less than 40, and even more preferably not less than 70, from the viewpoint of improving thermal conductivity in the orientation direction. An upper limit of the aspect ratio is not particularly limited, but is usually not more than 1000. The graphite particles (A) preferably have an aspect ratio of not less than 20 because orienting such graphite particles (A) in a thickness direction of the thermally conductive sheet makes it possible to further improve thermal conductivity in the thickness direction of the thermally conductive sheet and thus makes it possible to further reduce thermal resistance in the thickness direction of the thermally conductive sheet.

Examples of the graphite particles (A) used in an embodiment of the present invention include particles of, for example, scale-like graphite, scaly graphite, earthy graphite, artificial graphite, flaky graphite, acid-treated graphite, expanded graphite, and carbon fiber flakes.

The graphite particles (A) have an average particle size of preferably 20 μm to 1,000 μm, more preferably 30 μm to 500 μm, and particularly preferably 40 μm to 240 μm. Note here that the average particle size of the graphite particles (A) is a value determined by a laser diffraction/scattering particle size distribution analyzer (LA-920, manufactured by HORIBA, Ltd.).

In a case where the graphite particles (A) have an average particle size of not less than 20 μm, the graphite particles (A) are oriented in a desired direction in the thermally conductive sheet, so that a good heat transfer path is easily formed. Further, in a case where an upper limit of the average particle size of the graphite particles (A) is in the foregoing range, the graphite particles are exposed on a surface of the thermally conductive sheet. This allows heat transfer from a heat-generating body to the thermally conductive sheet to be better when the thermally conductive sheet is brought into contact with the heat-generating body.

Further, in a case where the graphite particles (A) have the plate-like shape, the graphite particles (A) have an average thickness of preferably 0.01 μm to 10 μm, more preferably 0.1 μm to 5 μm, and particularly preferably 0.3 μm to 3 μm. Note here that the average thickness of the graphite particles (A) can be determined as follows. Specifically, a sufficient number of (e.g., not less than 10) graphite particles (A) are observed with an ultra-high-resolution scanning electron microscope (S-4800, manufactured by Hitachi, Ltd.), the respective thicknesses of the graphite particles (A) are calculated, and the average thickness of the graphite particles (A) is determined as an average of the calculated thicknesses.

In a case where a lower limit of the average thickness of the graphite particles (A) is in the foregoing range, a heat transport quantity of one particle is increased, so that a good heat transfer path is easily formed. Further, in a case where an upper limit of the average thickness of the graphite particles (A) is in the foregoing range, the number per unit weight of the graphite particles (A) increases, and the graphite particles (A) interfere with each other and are thus oriented in a desired direction, so that a good heat transfer path is easily formed.

### (Organic Polymer Compound (B))

The organic polymer compound (B) not only functions as a binder but also makes it possible to improve flexibility of the thermally conductive sheet and allow good adhesion between a heat-generating body and a heat-dissipating body via the thermally conductive sheet.

The organic polymer compound (B) is not particularly limited and can be an organic polymer compound that is ordinarily used in a thermally conductive sheet.

Examples of the organic polymer compound (B) include an acrylic ester-based resin, a resin which has a main chain consisting of repeated siloxane bonds (silicone resin), a resin which has rubber elasticity at room temperature (elastomer resin), an epoxy resin, a fluorine resin, polyolefin, polyvinyl chloride, polyvinylidene chloride, polyvinyl acetate, an ethylene-vinyl acetate copolymer, polyvinyl alcohol, polyacetal, polyethylene terephthalate, polybutylene terephthalate, polyethylene naphthalate, polystyrene, polyacrylonitrile, polyphenylene ether, modified polyphenylene ether, aliphatic polyamides, aromatic polyamides, polyamideimide, polycarbonate, polyphenylene sulfide, polysulfone, polyether sulfone, polyether nitrile, polyether ketone, polyketone, polyurethane, a liquid crystal polymer, and ionomer. One type of these organic polymer compounds may be used individually, or two or more types thereof may be used in combination.

The organic polymer compound (B) may be either solid or liquid at normal temperature. Note that “normal temperature” refers to 20 °C in the present specification.

The Tg and weight average molecular weight of the organic polymer compound (B) are preferably in the same ranges as the preferable ranges of the Tg and weight average molecular weight of the acrylic ester-based resin which will be described later. This allows the thermally conductive sheet to bring about effects that are similar to those brought about in a case where the Tg and weight average molecular weight of the acrylic ester-based resin fall within the preferable ranges.

The content of the organic polymer compound (B) relative to a total weight of the thermally conductive sheet is preferably not less than 10% by weight, more preferably not less than 15% by weight, and even more preferably not less than 20% by weight. In a case where the content of the organic polymer compound (B) is not less than 10% by weight, it is possible to improve flexibility of the thermally conductive sheet and allow good adhesion between a heat-generating body and a heat-dissipating body via the thermally conductive sheet.

Further, the content of the organic polymer compound (B) relative to a total weight of the thermally conductive sheet is preferably not more than 60% by weight, more preferably not more than 50% by weight, and even more preferably not more than 40% by weight.

### <Acrylic Ester-Based Resin>

The organic polymer compound (B) preferably contains an acrylic ester-based resin. The use of the acrylic ester-based resin has the advantage of obtaining a thermally conductive sheet that has tackiness and that has elasticity such that the thickness of the thermally conductive sheet is restored. As the acrylic ester-based resin, one type of acrylic ester-based resin may be used alone, or two or more types of acrylic ester-based resins may be used in combination.

The acrylic ester-based resin includes a polymer of a monomer component containing at least one type of acrylic monomer selected from (meth)acrylic acids and (meth)acrylic esters and a copolymer of the acrylic monomer and another monomer. Note here that “(meth)acrylic” intends to include both “methacrylic” and “acrylic” in the present specification. Examples of the (meth)acrylic ester include methyl (meth)acrylate, ethyl (meth)acrylate, n-butyl (meth)acrylate, isobutyl (meth)acrylate, 2-ethylhexyl (meth)acrylate, and cyclohexyl (meth)acrylate.

Examples of the another monomer include acrylonitrile, glycidyl methacrylate, and 2-chloroethylvinyl ether. Note that acrylic rubber is obtained by copolymerizing (meth)acrylic ester with acrylonitrile, 2-chloroethylvinyl ether, or the like. Although the acrylic rubber is also classified as an elastomer resin described later, the acrylic rubber is considered to be included in an acrylic ester-based resin in the present specification.

More preferable examples of the acrylic ester-based resin include an acrylic ester-based resin containing butyl acrylate and/or 2-ethylhexyl acrylate as a monomer(s), a total amount of which is not less than 50% by weight relative to a total amount of a monomer component. Such an acrylic ester-based resin is preferable due to being easy to obtain high flexibility, having excellent chemical stability and excellent processability, and being easy to control tackiness. In addition, in the acrylic ester-based resin, including a cross-linked structure as long as flexibility is not impaired is preferable in terms of long-term adhesion retention and film strength. The cross-linked structure can be included by, for example, reacting a compound having an isocyanate group with a polymer having a hydroxyl group. Alternatively, the cross-linked structure can be included by, for example, reacting a compound having an epoxy group with a polymer having a carboxyl group.

The content of the acrylic ester-based resin relative to a weight of the entire organic polymer compound (B) is preferably not less than 15% by weight, more preferably not less than 20% by weight, even more preferably not less than 25% by weight, and particularly preferably not less than 30% by weight. The content of the acrylic ester-based resin may be, for example, 100% by weight relative to the weight of the entire organic polymer compound (B).

The acrylic ester-based resin has a Tg of preferably not higher than −35 °C, more preferably not higher than −50 °C, and even more preferably not higher than −60 °C. In a case where the acrylic ester-based resin has a Tg of not higher than −35 °C, it is easy for the acrylic ester-based resin to flow during attachment of the thermally conductive sheet in a hot press machine. This allows the thermally conductive sheet to have higher wettability to an adherend bonded thereto and have higher adhesion to the adherend. In addition, a lower limit of the Ty of the acrylic ester-based resin is not particularly limited and is, for example, not lower than −150 °C. The “Tg” described in the present specification can be calculated by, for example, a method described in Examples.

The acrylic ester-based resin may be a solid under normal temperature and normal pressure or may a liquid under normal temperature and normal pressure. Especially, the acrylic ester-based resin is preferably a liquid acrylic ester-based resin under normal temperature and normal pressure.

In the present specification, the “normal temperature” means 20 °C, and the “normal pressure” means 1 atm. Therefore, in other words, the acrylic ester-based resin is preferably an acrylic ester-based resin having a melting point of not higher than 20 °C. Note that the “melting point” described in the present specification is a melting point under conditions of normal pressure (1 atm). Further, in the present specification “being liquid” means that, when a container, such as a bottle and a can, in a state of holding a target resin therein is tilted under room temperature (20 °C), the resin flows. Further, the resin may be a resin in a massive form.

The acrylic ester-based resin has a weight average molecular weight of preferably not less than 50,000, more preferably not less than 150,000, and even more preferably not less than 250,000. In a case where the acrylic ester-based resin has a weight average molecular weight of as high as not less than 50,000, it is difficult for the acrylic ester-based resin to flow (i) when a press plate is released after hot pressing at the time of bonding of the thermally conductive sheet and an adherend and (ii) when an external force is applied to the thermally conductive sheet after the thermally conductive sheet is attached. This allows the thermally conductive sheet to have higher adhesion to an adherend.

In addition, the acrylic ester-based resin has a weight average molecular weight of preferably not more than 3,000,000, more preferably not more than 2,000,000, and even more preferably not more than 1,500,000. In a case where the acrylic ester-based resin has a weight average molecular weight of not more than 3,000,000, it is easy for the acrylic ester-based resin to flow during attachment of the thermally conductive sheet in a hot press machine. This allows the thermally conductive sheet to have higher wettability to an adherend bonded thereto and have higher adhesion to the adherend.

The weight average molecular weight can be measured with use of a calibration curve of standard polystyrene by, for example, gel permeation chromatography of a measurement target.

The organic polymer compound preferably contains an acrylic ester-based resin including a functional group. In the present specification, the acrylic ester-based resin including a functional group means that an acrylic ester-based resin contains a polymer of a monomer component that contains a monomer having a functional group.

The functional group includes a function of binding a plurality of the graphite particles (A). Thus, in a case where the acrylic ester-based resin includes the functional group, it is easy to form the composition in sheet form, and consequently, it is possible to more easily provide a thermally conductive sheet containing the composition. In addition, there is a case where the functional group acts on a substance of which a surface of the adherend is made, and contributes to adhesion between the thermally conductive sheet and the adherend. In that case, improved adhesion between the thermally conductive sheet and the adherend is also considered.

The type of the functional group is not particularly limited, provided that the functional group is a functional group which has a function of binding a plurality of the graphite particles (A). The functional group may be one type of functional group or may be two or more types of functional groups. For example, the functional group can be at least one type selected from the group consisting of a hydroxyl group, a carboxyl group, and an epoxy group, and is preferably a hydroxyl group and/or a carboxyl group, and more preferably a hydroxyl group. For example, the type of the functional group type can be identified by a known method such as structural analysis of the acrylic ester-based resin with use of NMR or the like.

The monomer having the functional group is not particularly limited, and preferable examples thereof include 2-hydroxyethyl (meth)acrylate, 3-hydroxypropyl (meth)acrylate, 4-hydroxybutyl (meth)acrylate, 2-hydroxy-1-methyl (meth)acrylate, acrylic acid, methacrylic acid, and glycidyl (meth)acrylate. Among these, the monomer having the functional group more preferably contains 2-ethylhexyl acrylate. In other words, the acrylic ester-based resin more preferably contains a copolymer containing 2-ethylhexyl acrylate as a monomer.

In an embodiment of the present invention, in a case where the content of the functional group relative to the weight of the entire acrylic ester-based resin is high, the graphite particles (A) more suitably bind to each other via the acrylic ester-based resin in the thermally conductive sheet. This results in further improvement in graphite binding capacity of the thermally conductive sheet. The content of the functional group relative to the weight of the entire acrylic ester-based resin is hereafter referred to as a “C of the functional group”. Note that the content C of the functional group is a sum of a content A of a functional group and a content B of a functional group, which will be described later.

A preferable range of the content C of the functional group is not less than 0.001 mmol/g and not more than 0.410 mmol/g. The preferable range of the content C of the functional group can vary depending on, for example, the type of the functional group and the type of graphite particles (A). For example, in a case where the functional group is at least one type selected from the group consisting of a hydroxyl group, a carboxyl group, and an epoxy group, the content C of the functional group is preferably not less than 0.001 mmol/g, more preferably not less than 0.010 mmol/g, and even more preferably not less than 0.090 mmol/g, from the viewpoint of further improving graphite binding capacity. Further, the content of the functional group can be expressed not only in a unit of “mmol/g” but also in a unit of “KOHmg/g”, which is commonly used. Specifically, for example, in a case where the functional group is at least one type selected from the group consisting of a hydroxyl group, a carboxyl group, and an epoxy group, the content C of the functional group is preferably not less than 0.056 KOHmg/g, more preferably not less than 0.56 KOHmg/g, and even more preferably not less than 5.05 KOHmg/g.

Further, the functional group can ordinarily also form a bond with a water molecule. Thus, in a case where the content C of the functional group is in a range that is equal to or less than a predetermined value, the acrylic ester-based resin has decreased affinity for water, which in turn decreases moisture absorbency. As a result, the moisture absorbency is controlled in a suitable range in a thermally conductive sheet. Consequently, the thermally conductive sheet has further improved adhesion after high temperature holding.

For example, in a case where the functional group is a hydroxyl group, the content C of the functional group is preferably not more than 0.371 mmol/g, more preferably not more than 0.340 mmol/g, and even more preferably not more than 0.300 mmol/g, from the viewpoint of further improving the adhesion after high temperature holding. Further, in a case where the functional group is a hydroxyl group, and the content C of the functional group is expressed in a unit of “KOHmg/g”, the content C of the functional group is preferably not more than 20.76 KOHmg/g, more preferably not more than 19.08 KOHmg/g, and even more preferably not more than 16.83 KOHmg/g.

For example, in a case where the functional group is a carboxyl group, the content C of the functional group is preferably not more than 0.410 mmol/g, more preferably not more than 0.360 mmol/g, and even more preferably not more than 0.300 mmol/g, from the viewpoint of further improving the adhesion after high temperature holding. Further, in a case where the functional group is a carboxyl group, and the content C of the functional group is expressed in a unit of “KOHmg/g”, the content C of the functional group is preferably not more than 23.00 KOHmg/g, more preferably not more than 20.20 KOHmg/g, and even more preferably not more than 16.83 KOHmg/g.

Note that conversion from mmol/g to KOHmg/g is calculated by multiplying mmol/g by 56.1056 mg/mmol.

Examples of a method for measuring the content C of the functional group include, but not particularly limited to, a method including steps (1) to (3) below.

(1) A known method is used to extract the acrylic ester-based resin from the thermally conductive sheet and measure a weight of the entire extracted acrylic ester-based resin.

(2) ¹HNMR, for example, is used to measure a substance amount (unit: mmol) of the functional group in the acrylic ester-based resin extracted in the step (1).

(3) The content (unit: mmol/g) of the functional group is calculated by dividing, by the weight of the entire acrylic ester-based resin which weight has been measured in the step (1), the substance amount of the functional group in the acrylic ester-based resin which substance amount has been measured in the step (2).

Assume that weight average molecular weights of all polymers contained in the acrylic ester-based resin, a content of a monomer having the functional group in all monomers constituting the polymers, and a content ratio of each of the polymers are known. In this case, on the basis of those, the content C of the functional group can also be calculated.

The acrylic ester-based resin more preferably contains an acrylic resin including a functional group and an acrylic block copolymer. The acrylic resin including the functional group may be the one constituted by an acrylic resin including one type of functional group or may be a mixture of acrylic resins having two or more types of functional groups. The acrylic block copolymer may be the one constituted by one type of acrylic block copolymer or may be a mixture of two or more types of acrylic block copolymers.

### <Acrylic Resin Including Functional Group>

The acrylic resin including the functional group has a glass transition temperature (Tg) of preferably not higher than −35 °C, more preferably not higher than −50 °C, and even more preferably not higher than −60 °C. In a case where the acrylic resin including the functional group has a Tg of not higher than −35 °C, it is easy for the acrylic ester-based resin to flow during attachment of the thermally conductive sheet in a hot press machine. This allows the thermally conductive sheet to have higher wettability to an adherend bonded thereto and have higher adhesion to the adherend. In addition, a lower limit of the Tg of the acrylic resin including the functional group is not particularly limited and is, for example, not lower than −150 °C.

The acrylic resin including the functional group has a weight average molecular weight of preferably not less than 100,000, more preferably not less than 300,000, and even more preferably not less than 500,000. Further, the acrylic resin including the functional group has a weight average molecular weight of preferably not more than 3,000,000, more preferably not more than 2,000,000, and even more preferably not more than 1,500,000. By adjusting the weight average molecular weight of the acrylic resin including the functional group in the above-described preferable range, it is possible to suitably control the weight average molecular weight of the acrylic resin including a functional group in the above-described preferable range.

The molecular weight distribution (weight average molecular weight/number average molecular weight) of the acrylic resin including the functional group is preferably 1.0 to 10.0.

The acrylic resin including the functional group may be a solid under normal temperature and normal pressure or may a liquid under normal temperature and normal pressure. The acrylic resin including the functional group is preferably a liquid under normal temperature and normal pressure. Therefore, in other words, the acrylic resin including the functional group is preferably an acrylic resin including a functional group having a melting point of not higher than 20 °C.

The acrylic resin including the functional group preferably has not less than 50% by weight of a repeating unit derived from an acrylic monomer. The acrylic resin including the functional group includes a polymer at least some of monomers of which have the functional group and whose monomer component contains at least one type of acrylic monomer. The acrylic resin including the functional group also includes a copolymer at least some of monomers of which have the functional group and which is composed of an acrylic monomer and another monomer. As the acrylic monomer and the another monomer, the acrylic monomer and the another monomer which have been described earlier as the monomers that can constitute the acrylic ester-based resin can be employed.

The percentage of the weight of the monomer having the functional group to the weight of all monomers constituting the acrylic resin including the functional group is preferably 0.1% by weight to 5.2% by weight, and more preferably 0.3% by weight to 4.0% by weight. Further, the percentage of the substance amount of the monomer having the functional group to the substance amount of all monomers constituting the acrylic resin including the functional group is preferably 0.1 mol % to 5.0 mol %, and more preferably 0.3 mol % to 4.0 mol %. It is preferable to adjust the above percentages in the above-described ranges in order to suitably control the content of the functional group in the acrylic resin including the functional group in the later-described range. As the monomer having the functional group, the monomer having the functional group which has been described earlier as the monomer that can constitute the acrylic ester-based resin can be employed. The content of the functional group relative to the weight of the acrylic resin including the functional group is hereafter referred to as a “content A of the functional group”.

From the viewpoint of further improving the graphite binding capacity, the content A of the functional group is preferably not less than 0.010 mmol/g, and more preferably not less than 0.050 mmol/g, relative to the weight of the entire acrylic resin having the functional group.

Further, when the thermally conductive sheet is held in a high temperature environment and is subjected to application of heat, water that has been absorbed by the thermally conductive sheet is discharged to the outside by the heat. This changes the shape of the thermally conductive sheet and thus can decrease adhesion to an adherend after the high temperature holding. Specifically, a thermally conductive sheet containing an acrylic ester-based resin having high moisture absorbency is considered to be in a state of having absorbed a large amount of water from the air. In that case, it is inferred that a large amount of water discharged increases a degree of the change in shape, so that adhesion to the adherend tends to decrease due to production of a gap between the thermally conductive sheet and the adherend. Furthermore, in a case where the acrylic ester-based resin is poorly water soluble, it is considered that it is possible to realize a thermally conductive sheet having excellent adhesion to an adherend after high temperature holding.

Note here that, in an embodiment of the present invention, in a case where the content A of the functional group is low, the functional group can usually react with a water molecule (H₂O). Thus, the acrylic ester-based resin has decreased affinity for water, which decreases moisture absorbency. As a result, the moisture absorbency is controlled in a suitable range in a thermally conductive sheet. Consequently, the thermally conductive sheet has further improved adhesion after high temperature holding.

Specifically, for example, in a case where the functional group is a hydroxyl group, the content A of the functional group is preferably not more than 0.371 mmol/g, more preferably not more than 0.340 mmol/g, and even more preferably not more than 0.300 mmol/g, relative to the weight of the entire acrylic resin having the functional group, from the viewpoint of improving the adhesion after high temperature holding.

Further, for example, in a case where the functional group is a carboxyl group, the content A of the functional group is preferably not more than 0.410 mmol/g, more preferably not more than 0.360 mmol/g, and even more preferably not more than 0.300 mmol/g, relative to the weight of the entire acrylic resin having the functional group, from the viewpoint of improving the adhesion.

In a case where the content A of the functional group is in these ranges, it is possible to suitably control the aforementioned content C of the functional group in a preferable range. Note that examples of a method for measurement of the content A of the functional group include a method that is identical to a method for measurement of the content C of the functional group, except that the acrylic resin including the functional group is a target.

The acrylic resin including the functional group may be formed of a random copolymer or a block copolymer. Note, however, that a random copolymer is more preferable due to its availability. The acrylic resin including the functional group may have a linear or branched structure. Note, however, that a linear structure is more preferable due to its availability.

### <Acrylic Block Copolymer>

The acrylic block copolymer has a block structure and thus has a Tg at low and high temperatures. Since the acrylic block copolymer has a Tg at a low temperature, a thermally conductive sheet containing the acrylic block copolymer has softness even at a low temperature. Therefore, the thermally conductive sheet containing the acrylic block copolymer can have adhesion even when exposed to a low temperature. In addition, since the acrylic block copolymer has a Tg at a high temperature, the thermally conductive sheet containing the acrylic block copolymer does not become excessively soft even at a high temperature and has elasticity. Therefore, the thermally conductive sheet containing the acrylic block copolymer can have adhesion even when exposed to a high temperature. Thus, the thermally conductive sheet has excellent adhesion after high temperature holding.

The acrylic block copolymer has a Tg on a low temperature side of preferably not higher than −35 °C, and more preferably not higher than −50 °C. In a case where the acrylic block copolymer has a Tg on the low temperature side of not higher than −35 °C, it is easy for the acrylic ester-based resin to flow during attachment of the thermally conductive sheet in a hot press machine. This allows the thermally conductive sheet to have higher wettability to an adherend bonded thereto and have higher adhesion to the adherend. In addition, a lower limit of the Tg on the low temperature side of the acrylic block copolymer is not particularly limited and is, for example, not lower than −150 °C, and preferably not lower than −55 °C.

A lower limit of the Tg on the high temperature side of the acrylic block copolymer is preferably not lower than 100 °C, and more preferably not lower than 102 °C. An upper limit of the Tg on the high temperature side of the acrylic block copolymer is preferably not higher than 120 °C, and more preferably not higher than 118 °C. In a case where the Tg on the high temperature side is in the above-described range, it is possible to more suitably prevent a thermally conductive sheet from becoming excessively soft at a high temperature and allow the thermally conductive sheet to more suitably retain elasticity under a high temperature. Consequently, it is possible to further improve adhesion after high temperature holding.

The acrylic block copolymer has a weight average molecular weight of preferably not less than 10,000, more preferably not less than 30,000, and even more preferably not less than 50,000. In addition, the acrylic block copolymer has a weight average molecular weight of preferably not more than 3,000,000, more preferably not more than 2,000,000, and even more preferably not more than 1,500,000. By adjusting the weight average molecular weight of the acrylic block copolymer in the above-described preferable range, it is possible to suitably control the weight average molecular weight of the acrylic ester-based resin in the later-described preferable range. The molecular weight distribution (weight average molecular weight/number average molecular weight) of the acrylic block copolymer is preferably 1.0 to 2.0.

The acrylic block copolymer may be a solid under normal temperature and normal pressure or may a liquid under normal temperature and normal pressure. The acrylic block copolymer is preferably a liquid under normal temperature and normal pressure. Therefore, in other words, the acrylic block copolymer is preferably an acrylic block copolymer having a melting point of not higher than 20 °C.

The acrylic block copolymer preferably has not less than 50% by weight of a repeating unit derived from an acrylic monomer. The acrylic block copolymer includes a copolymer whose monomer component contains two or more types of acrylic monomers. The acrylic block copolymer also includes a copolymer which is composed of at least one type of acrylic monomer and at least one type of another monomer. As the acrylic monomer and the another monomer, the acrylic monomer and the another monomer which have been described earlier as the monomers that can constitute the acrylic ester-based resin can be employed.

The acrylic block copolymer is a block copolymer. Note here that the block copolymer means a polymer having a structure in which two or more types of blocks of different chemical structures are linked to each other in the majority of a main chain, preferably in the entirety of the main chain. The block is a block composed of two or more repeating units derived from a monomer. The majority of the main chain means a portion constituted by, for example, not less than 95%, preferably not less than 978, of a total number of repeating units that are derived from a monomer and that constitute the main chain.

Examples of the structure of the block of the acrylic block copolymer include a diblock (A-B), a triblock (A-B-A or A-B-C), and a tetrablock (e.g., A-B-A-B or A-B-C-D). From the viewpoint of improving adhesion at a high temperature, an A-B-A triblock copolymer is preferable.

Repeating units constituting a block A of the A-B-A triblock copolymer are preferably repeating units derived from a monomer, such as methyl methacrylate, such that the Tg of a homopolymer is 100 °C to a temperature equal to or higher than 120 °C. Repeating units constituting a block B are preferably repeating units derived from a monomer, such as butyl acrylate and 2-ethylhexyl acrylate, such that the Tg of a homopolymer is −60 °C to a temperature equal to or lower than −40 °C. Preferable examples of the A-B-A triblock copolymer are poly(methyl methacrylate)-poly(butyl acrylate)-poly(methyl methacrylate), poly(methyl methacrylate)-poly(2-ethylhexyl acrylate)-poly(methyl methacrylate), and poly(methyl methacrylate)-random poly(butyl acrylate, 2-ethylhexyl acrylate)-poly(methyl methacrylate).

A weight ratio among the blocks of the A-B-A triblock copolymer is preferably A/B/A=1 to 25/98 to 50/1 to 25, and a weight average molecular weight of the A-B-A triblock copolymer is preferably 10,000 to 3,000,000.

The acrylic block copolymer may include a functional group. The type of the functional group is not particularly limited. For example, the functional group can be at least one type selected from the group consisting of a hydroxyl group, a carboxyl group, and an epoxy group, and is preferably a hydroxyl group and/or a carboxyl group, and more preferably a hydroxyl group. Meanwhile, the functional group can usually react with a water molecule (H₂O). Thus, in a case where the content of the functional group is low, preferably in a case where the acrylic block copolymer does not include the functional group, the acrylic ester-based resin has decreased affinity for water, which decreases moisture absorbency. As a result, as in the foregoing case where the content A of the functional group is low, the moisture absorbency is controlled in a suitable range in a thermally conductive sheet. Consequently, the thermally conductive sheet has further improved adhesion after high temperature holding. From the foregoing viewpoint, the content of the functional group in the acrylic block copolymer is preferably low.

The content of the functional group relative to the weight of the acrylic block copolymer is hereafter referred to as a “content B of the functional group”. Specifically, the content B of the functional group is preferably not more than 0.020 mmol/g, and more preferably less than 0.010 mmol/g, relative to the weight of the entire acrylic block copolymer. Note that it is particularly preferable that the content B of the functional group be 0 mmol/g, i.e., the acrylic block copolymer do not include the functional group. Note that examples of a method for measurement of the content B of the functional group include a method that is identical to the foregoing method for measurement of the content C of the functional group, except that the acrylic block copolymer is a target.

Further, an acrylic block copolymer having a low content of the functional group has high heat resistance. Such a structure has higher stability to heat. Thus, the acrylic block copolymer having a low content of the functional group is less likely to generate a radical when heat is applied than an acrylic block copolymer having a high content of the functional group. Accordingly, in a case where the content B of the functional group is low, the amount of radicals generated in the acrylic ester-based resin when heat is applied is smaller than that in a case where the content B of the functional group is high. This makes it difficult for the chain reaction to proceed in a thermally conductive sheet containing the acrylic ester-based resin in a case where the content B of the functional group is low. As a result, in a case where the content B of the functional group is low in the thermally conductive sheet, the tackiness of the acrylic ester-based resin is much less likely to decrease when heat is applied, and the thermally conductive sheet has more excellent tackiness after high temperature holding.

Hereinafter, in the acrylic ester-based resin, a ratio of the weight of the acrylic resin including the functional group with respect to the weight of the acrylic block copolymer (acrylic resin including the functional group/acrylic block copolymer) is referred to as “ratio A”. The ratio A being equal to or higher than a predetermined value means that the content of the acrylic resin including the functional group and the content of the functional group are suitably high in the acrylic ester-based resin. In that case, the graphite binding capacity of a thermally conductive sheet due to the presence of the functional group is further improved. From the viewpoint of further improving the graphite binding capacity of a thermally conductive sheet, the ratio A is preferably not less than 0.02, more preferably not less than 0.05, and even more preferably not less than 0.1.

The ratio A being equal to or lower than a predetermined value means that the content of the acrylic block copolymer is suitably high in the acrylic ester-based resin. In that case, adhesion after high temperature holding of a thermally conductive sheet due to the presence of the acrylic block copolymer is further improved. From the viewpoint of further improving the adhesion after high temperature holding of a thermally conductive sheet, the ratio A is preferably not more than 50, more preferably not more than 25, and even more preferably not more than 10.

Note that, from the viewpoint of improving, with good balance, the graphite binding capacity of a thermally conductive sheet and the adhesion after high temperature holding thereof, the ratio A is preferably in the foregoing ranges, more preferably 1.2 to 8, and particularly preferably 1.5 to 5.

### Composition

In an embodiment of the present invention, a content of the graphite particles (A) in the composition is preferably 30% by weight to 80% by weight, more preferably 35% by weight to 75% by weight, and even more preferably 40% by weight to 70% by weight, relative to a total weight of the composition. The content of the graphite particles (A) that is not less than 30% by weight is preferable because sufficient thermal conductivity is exhibited. Further, the content of the graphite particles (A) that is not more than 80% by weight is preferable because flexibility and adhesion are excellent.

In a case where the content of the graphite particles (A) is in the above-described range, a ratio between the graphite particles (A) and the organic polymer compound (B) in the composition becomes a more preferable ratio to satisfy the requirement that “the (a2) be higher than the (a1)”. This makes it easier to produce the thermally conductive sheet of an aspect of the present invention.

In an embodiment of the present invention, a content of the organic polymer compound (B) in the composition is preferably 10% by weight to 60% by weight, more preferably 15% by weight to 50% by weight, and even more preferably 20% by weight to 40% by weight, relative to a total weight of the composition. The content of the organic polymer compound (B) that is not less than 10% by weight is preferable because it is possible to improve flexibility of the thermally conductive sheet and allow good adhesion between a heat-generating body and a heat-dissipating body via the thermally conductive sheet. Further, a higher content of the organic polymer compound (B) in a range of not more than 60% by weight is preferable because it is possible to suitably immobilize the graphite particles (A), and adhesion between the thermally conductive sheet and a semiconductor and/or a spreader increases.

The above-described composition may contain, if necessary, one or more types of additives such as a plasticizer, a flame retardant, an anti-aging agent, a thermal stabilizer, a colorant, an antistatic agent, a tackifier, and a filler differing from the graphite particles (A). The plasticizer can be, for example, polybutene and/or a phosphorus-based flame retardant. Containing polybutene and/or a phosphorus-based flame retardant allows a thermally conductive sheet to exhibit an effect of improving wettability to silicon and/or a spreader and reducing thermal resistance. The flame retardant can be, for example, a phosphorus-based flame retardant. The phosphorus-based flame retardant has a function of inhibiting the burning of a resin.

Note that, in a method for producing a thermally conductive sheet in accordance with an embodiment of the present invention, which method will be described later, a mixture containing the graphite particles (A), the organic polymer compound (B), and a solvent is used to form a primary sheet. In the present specification, the term “composition” does not mean the mixture, but means a composition obtained after a solvent is removed by, for example, drying, i.e., a composition contained in an electrically conductive sheet that is finally obtained.

In a case where the thermally conductive sheet contains the additive(s), a content of the additive(s) need only not impair an effect of the present invention and is not particularly limited. A preferable content of the additive(s) is, for example, not more than 50% by weight relative to the weight of the thermally conductive sheet.

Examples of the anti-aging agent include a phenol-based anti-aging agent and an amine-based anti-aging agent. The anti-aging agent is contained in an amount of preferably 0.1 parts by weight to 10 parts by weight, and more preferably 0.2 parts by weight to 8 parts by weight, relative to 100 parts by weight, which is a weight of the entire organic polymer compound (B).

Note that the content of the graphite particles (A), the organic polymer compound (B), and the additive(s) in the foregoing thermally conductive sheet can be the same as the content of the graphite particles (A), the organic polymer compound (B), and the additive(s) relative to the weight of the entire composition.

### (Orientation of Graphite Particles (A))

The thermally conductive sheet is preferably such that the graphite particles (A) are oriented in a thickness direction of the thermally conductive sheet. In this case, the thermally conductive sheet has higher thermal conductivity in the thickness direction in which the graphite particles (A) are oriented. This reduces thermal resistance in the thickness direction in which the graphite particles (A) are oriented. Note that, in the thermally conductive sheet, not all the graphite particles (A) need to be oriented in the thickness direction of the thermally conductive sheet. In the thermally conductive sheet, it is only necessary that at least some of the graphite particles (A) be oriented in the thickness direction of the thermally conductive sheet, and it is possible to improve thermal conductivity in the thickness direction in which the graphite particles (A) are oriented.

The “graphite particles (A) being oriented in the thickness direction of the thermally conductive sheet” means that an angle of a six-membered carbon ring surface in a crystal of the graphite particles (A) to a sheet surface of the thermally conductive sheet is more than 45°. The angle is more preferably not less than 50°, even more preferably not less than 70°, and particularly preferably not less than 80°. Note that except for a case where two angles formed between the six-membered carbon ring surface and the sheet surface of the thermally conductive sheet are 90°, the “angle of the six-membered carbon ring surface to the sheet surface of the thermally conductive sheet” is intended to mean a smaller angle. In the graphite particles (A), the six-membered carbon ring surface in the crystal of the graphite particles (A) is oriented in a surface direction of a scale or a flake in the case of the graphite particles (A) having a plate-like shape such as a scale-like shape or a flaky shape, and is oriented in a major axis direction of particles in the case of the graphite particles (A) having a spheroidal shape, a needle shape, a rod shape, a fibrous shape, or an irregular shape. Note that a direction of the major axis of the graphite particles (A) matches a direction of the maximum length of the graphite particles (A).

The angle of the six-membered carbon ring surface in the crystal of the graphite particles (A) to the sheet surface, which is a surface of the thermally conductive sheet, can be measured by using a scanning electron microscope to observe a cross section of the thermally conductive sheet in the thickness direction. First, a thin film section of a central part of the thermally conductive sheet in the thickness direction is produced. Then, the scanning electron microscope is used to observe the graphite particles (A) in the thin film section and measure an angle formed between the major axis of any 20 graphite particles (A) and the sheet surface, so that the angle of the six-membered carbon ring surface in the crystal of the graphite particles (A) to the sheet surface can be determined. In the present specification, the foregoing angles of not less than 45°, not less than 50°, not less than 70°, and not less than 80° each mean that an average of values measured as described above is not less than a corresponding angle. In a case where an angle formed between the major axis of the graphite particles (A) and the sheet surface is more than 90°, a supplementary angle to the angle is regarded as a measurement value.

(Physical Properties, Etc. Of Thermally Conductive Sheet)

The thermally conductive sheet in accordance with an embodiment of the present invention has a thermal resistance of preferably not more than 0.20 cm²K/W, more preferably not more than 0.12 cm²K/W, even more preferably not more than 0.10 cm²K/W, and particularly preferably not more than 0.085 cm²K/W. Note here that in the present specification, thermal resistance refers to thermal conduction in the thickness direction of the thermally conductive sheet and refers to a thermal resistance value measured by a method described in Examples. In a case where the thermal resistance is not more than 0.20 cm²K/W, the thermally conductive sheet has excellent thermal conductivity and has excellent heat dissipation characteristics when the thermally conductive sheet is interposed between a heat-generating body and a heat-dissipating body and used as a heat dissipation device. The thermal resistance that is lower is preferable.

The thermally conductive sheet in accordance with an embodiment of the present invention has a thickness of preferably not more than 500 μm, more preferably not more than 200 μm, even more preferably not more than 140 μm, further more preferably not more than 100 μm, still more preferably not more than 95 μm, and particularly preferably not more than 80 μm. Note here that in the present specification, the “thickness of the thermally conductive sheet” refers to a thickness measured by a method described in Examples. The thermally conductive sheet that has a thickness of not more than 500 μm is preferable because such a thermally conductive sheet can be attached to a heat-generating body such as an electronic component even in a narrow space. As long as the thermally conductive sheet exhibits a function as a thermally conductive sheet, the thickness of the thermally conductive sheet has a lower limit that is not particularly limited and that is preferably not less than 3 μm, and more preferably not less than 5 μm.

A sulfur content percentage of the thermally conductive sheet in accordance with an embodiment of the present invention is preferably not more than 0.30% by weight, more preferably not more than 0.25% by weight, even more preferably not more than 0.20% by weight, and particularly preferably not more than 0.10% by weight, relative to a total weight of the thermally conductive sheet. Note here that in the present specification, the sulfur content percentage of the thermally conductive sheet refers to a sulfur content percentage measured by a method described in Examples. The sulfur content percentage of the thermally conductive sheet of not more than 0.30% by weight is preferable because it is less likely to corrode an electronic component with which the thermally conductive sheet is in contact. The sulfur content percentage of the thermally conductive sheet is preferably lower and has a lower limit that is exemplified by, but not particularly limited to, not less than 0.01% by weight.

The thermally conductive sheet in accordance with an embodiment of the present invention has a hardness of preferably not less than 65, more preferably not less than 70, even more preferably not less than 75, and particularly preferably not less than 80, at 20 °C. Note here that in the present specification, the “hardness at 20 °C of the thermally conductive sheet” refers to a hardness measured by a method described in Examples. The thermally conductive sheet that has a hardness of not less than 65 at 20 °C is preferable because such a thermally conductive sheet is sufficiently hard and thus can be sliced to have a small thickness. The thermally conductive sheet has a hardness of preferably not more than 95, more preferably not more than 90, and even more preferably not more than 88, at 20 °C. The thermally conductive sheet that has a hardness of not more than 95 at 20 °C allows sufficient adhesion of the thermally conductive sheet to a component with which the thermally conductive sheet is in contact. It is therefore possible to successfully transfer heat and sufficiently relax thermal stress.

The thermally conductive sheet in accordance with an embodiment of the present invention has a hardness of preferably more than 60, more preferably not less than 63, and even more preferably not less than 65, at 70 °C. Note here that in the present specification, the “hardness at 70 °C of the thermally conductive sheet” refers to a hardness measured by a method described in Examples. The thermally conductive sheet that has a hardness of more than 60 at 70 °C is preferable because such a thermally conductive sheet is sufficiently hard and thus can be sliced to have a small thickness. The thermally conductive sheet has a hardness of preferably not more than 90, more preferably not more than 85, and even more preferably not more than 83, at 70 °C. The thermally conductive sheet that has a hardness of not more than 90 at 70 °C allows sufficient adhesion of the thermally conductive sheet to a component with which the thermally conductive sheet is in contact. It is therefore possible to successfully transfer heat and sufficiently relax thermal stress.

A numerical value (unit: N·mm) representing tackiness measured by a method described in Examples can be used to evaluate tackiness of the thermally conductive sheet in accordance with an embodiment of the present invention. The tackiness of the thermally conductive sheet is preferably not less than 0.8 N·mm, more preferably not less than 1.0 N·mm, and even more preferably not less than 1.2 N·mm. The tackiness has an upper limit that can be exemplified by, but is not particularly limited to, less than 5.0 N·mm.

In a case where the tackiness of the thermally conductive sheet is not less than 0.8 N·mm, accurate positioning can be achieved when the thermally conductive sheet is temporarily bonded to an adherend. Further, positional displacement does not occur even in a case where the adherend is moved while being temporarily bonded to the thermally conductive sheet. Thus, more excellent adhesion can be exhibited when hot pressing is carried out. In a case where the tackiness of the thermally conductive sheet is less than 5.0 N·mm, air between the thermally conductive sheet and an adherend easily escapes when the thermally conductive sheet is temporarily bonded to the adherend. Furthermore, during bonding of the thermally conductive sheet and the adherend by hot pressing, air entrained between the thermally conductive sheet and the adherend easily escapes. In view of the above, in a case where the tackiness of the thermally conductive sheet of an aspect of the present invention is less than 5.0 N·mm, it is possible to achieve more sufficient adhesion of the thermally conductive sheet to a component with which the thermally conductive sheet is in contact.

The temporary bonding property of the thermally conductive sheet in accordance with an embodiment of the present invention can be evaluated by peeling off a thermally conductive sheet having a size of 40 mm×40 mm from a separator (mount) and attaching the thermally conductive sheet to a silicon wafer measuring 50 mm×50 mm. The fact that a thermally conductive sheet has excellent temporary bonding property means the following:
It is easy to peel off the thermally conductive sheet from the separator.
The thermally conductive sheet can be fixed on the silicon wafer and attached accurately.
The thermally conductive sheet is not detached even when the silicon wafer is transported or reversed.
Air entrained between the silicon wafer and the thermally conductive sheet easily escapes.

The initial adhesion of the thermally conductive sheet in in accordance with an embodiment of the present invention is adhesion when the thermally conductive sheet and an adherend are bonded to each other, and can be measured by the method described in Examples (described later). In a case where adhesion is not excellent at the stage of completion of bonding of a thermally conductive sheet and an adherend to each other, the thermally conductive sheet is not expected to have adhesion after high temperature holding and adhesion after a heat cycle, which will be described later. Thus, it is first required that the thermally conductive sheet sufficiently have initial adhesion. The initial adhesion can be measured by the method described in Examples (described later), and the evaluation described in Examples is preferably “A” or “B”.

The adhesion after high temperature holding of the thermally conductive sheet in accordance with an embodiment of the present invention is adhesion between the thermally conductive sheet and the adherend in a case where the thermally conductive sheet is held in a high temperature environment. There is a case in which the thermally conductive sheet may be held in a high temperature environment while adhering to an adherend. Thus, the thermally conductive sheet preferably has excellent adhesion after high temperature holding. The adhesion after high temperature holding can be measured by the method described in Examples, and the evaluation described in Examples is preferably “A” or “B”.

The adhesion after a heat cycle of the thermally conductive sheet in accordance with an embodiment of the present invention is adhesion between the thermally conductive sheet and the adherend in a case where the thermally conductive sheet is held in an environment in which a change in temperature between low temperature and high temperature is repeated. There is a case in which the thermally conductive sheet may be held in a state in which a change in temperature between low temperature and high temperature is repeated, while adhering to an adherend. Thus, the thermally conductive sheet preferably has excellent adhesion after a heat cycle. The adhesion after a heat cycle can be measured by the method described in Examples, and the evaluation described in Examples is preferably “A” or “B”.

### [2. Method for Producing Thermally Conductive Sheet]

A method for producing a thermally conductive sheet in accordance with an embodiment of the present invention includes: a primary sheet forming step of forming, in sheet form, a mixture containing graphite particles (A), an organic polymer compound (B), and a solvent to obtain a primary sheet; a laminate forming step of laminating the primary sheet to obtain a primary sheet laminate; and a slicing step of slicing a laminate cross section of the primary sheet laminate to obtain a thermally conductive sheet.

By having such a configuration, the above-described production method enables production of a thermally conductive sheet in accordance with an embodiment of the present invention. Thus, it is possible to provide a thermally conductive sheet that exhibits a low thermal resistance value, excellent tackiness, excellent initial adhesion, excellent adhesion after high temperature holding, and excellent adhesion after a heat cycle.

### (Primary Sheet Forming Step)

In the primary sheet forming step, a mixture containing graphite particles (A), an organic polymer compound (B), and a solvent is formed in sheet form to obtain a primary sheet.

Note here that the graphite particles (A), the organic polymer compound (B), and the composition containing the graphite particles (A) and the organic polymer compound (B) are as described in the above [1.] section.

Conventionally known as the primary sheet forming step is a method in which graphite particles (A), an organic polymer compound (B), and, if necessary, the above-described additive(s) are melted and kneaded without addition of a solvent, and the obtained kneaded product is formed in sheet form to obtain a primary sheet. The inventor of the present invention confirmed that there was no difference in carbon concentration on the surface of a thermally conductive sheet which was produced with use of the primary sheet obtained by such a method.

Thus, the inventor of the present invention conducted diligent studies and produced a primary sheet with use of a mixture containing graphite particles (A), an organic polymer compound (B), and a solvent, instead of melting and kneading without addition of a solvent. As a result, it was found that subjecting the primary sheet to the laminate forming step and a slicing step resulted in obtaining of a thermally conductive sheet of an aspect of the present invention in which there was a difference in carbon concentration.

Although it is not clear why the use of the above-described mixture forms a difference in carbon concentration, it is considered that the solvent causes variations in the degree of dispersion of the graphite particles (A) and the organic polymer compound (B) between the interior of the primary sheet and the surface thereof, and such variations are reflected in the laminate. In addition, it is considered that, in a process of applying a coating of a solution containing the graphite particles (A) and the organic polymer compound (B) and then performing heating to dry the solvent, the organic polymer compound (B) translocates to a surface layer of the primary sheet, and, after the lamination, a portion having a low carbon concentration is present. Further, it is also considered that the organic polymer compound (B) could have been seeped into an interface between the primary sheet and the primary sheet during pressing in the laminate forming step. Note that the present invention is not limited to such an inference.

Examples of the solvent include: aromatic hydrocarbon solvents such as toluene and xylene; ester-based solvents such as ethyl acetate and butyl acetate; ketone-based solvents such as methyl ethyl ketone and methyl isobutyl ketone (MIBK); and cellosolve-based solvents such as butyl cellosolve, phenyl cellosolve, and dimethyl cellosolve. The amount of the solvent is preferably such that the total concentration of the graphite particles (A), the organic polymer compound (B), and the additive(s) is 10% by weight to 50% by weight, and is more preferably such that the total concentration of the graphite particles (A), the organic polymer compound (B), and the additive(s) is 20% by weight to 40% by weight. The primary sheet that is produced at this concentration is preferable because there is a moderate space between the graphite particles, so that orientation of the graphite particles becomes better during sheet production and lamination pressing.

The primary sheet forming step is preferably a step of forming the primary sheet by applying a coating of the mixture. Such a step, which is also referred to as a scraping-off method, is a method for obtaining a primary sheet by pouring the mixture into a mold and carrying out drying. This method is preferable because it is easy to obtain a thermally conductive sheet having a difference in carbon concentration on the surface thereof. In the above step, the solvent is removed.

The primary sheet forming step is preferably a step of forming the primary sheet by applying a coating of the mixture and then carrying out drying. According to this configuration, drying is carried out separately after the application of a coating. Thus, it is possible to further remove the solvent. Therefore, it is possible to obtain a thermally conductive sheet in which the amount of residual solvent is minimized. Examples of a method for applying a coating include the scraping-off method described above, and examples of a method for drying include air-drying or heating in an oven.

The thickness of the composition formed in sheet form is preferably not less than 20 times, and more preferably 20 times to 100 times the average of the maximum length or the major axis of the graphite particles (A). The thickness that is in the above range is preferable because a sheet of high strength is obtained, and, after lamination pressing, the graphite is easy to orient. Further, the thickness that is in the above range is preferable because it is easy to obtain a thermally conductive sheet having a difference in carbon concentration on the surface thereof.

### (Laminate Forming Step)

The laminate forming step is a step of laminating the primary sheet to obtain a primary sheet laminate. A method for laminating the primary sheet is exemplified by, but not particularly limited to, a method of stacking a plurality of primary sheets and a method of folding a primary sheet. The primary sheet is preferably laminated with the graphite particles (A) aligned in the sheet surface.

Pressure at which the primary sheet is laminated is not particularly limited and is adjusted to be so weak as not to break a slice surface in a subsequent slicing step and so strong as to achieve successful adhesion between primary sheets. Further, lamination may be carried out under heating as appropriate.

The pressure at which the primary sheet is laminated may be applied every time each single primary sheet is laminated, may be applied for each plurality of primary sheets, or may be applied after all primary sheets are stacked. Preferable examples of a method for applying the pressure include a method in which pressure is applied every time each single primary sheet or a plurality of primary sheets is/are laminated/stacked and pressure is applied after all primary sheets are stacked. In such a case, pressure and temperature that are applied every time each single primary sheet or a plurality of primary sheets is/are laminated/stacked are not particularly limited. For example, the pressure is 1 kgf/cm² to 100 kgf/cm², and the temperature is 20 °C to 200 °C. Pressure and temperature that are applied after all primary sheets are stacked are also not particularly limited, For example, the pressure is 1 kgf/cm² to 100 kgf/cm², and the temperature is 20 °C to 200 °C

### (Slicing Step)

In the slicing step, a laminate cross section of the primary sheet laminate is sliced to obtain a thermally conductive sheet. An angle at which the laminate cross section of the primary sheet laminate is sliced is not particularly limited. More preferably, the laminate cross section of the primary sheet laminate is sliced at an angle of not more than 45°, even more preferably at an angle of 0° to 30°, and particularly preferably at an angle of 0° to 15°, relative to a direction in which the sheets are stacked, to obtain a thermally conductive sheet. By slicing at an angle of not more than 45° relative to the direction in which the sheets are stacked, a thermally conductive sheet having excellent thermal conductivity can be obtained.

Examples of a method for slicing the primary sheet laminate include, but not particularly limited to, a multi-blade method, a laser processing method, a water jet method, and a knife processing method.

A method for producing a thermally conductive sheet in in accordance with an embodiment of the present invention including the above steps enables a thermally conductive sheet of an aspect of the present invention to be obtained.

### SUMMARY

An embodiment of the present invention includes the following features.

<1> A thermally conductive sheet including a composition containing graphite particles (A) and an organic polymer compound (B),
the graphite particles (A) being oriented in a thickness direction of the thermally conductive sheet, wherein
when a first area measuring 500 μm×50 μm and a second area measuring 500 μm×50 μm are set on a surface of the thermally conductive sheet,
at least one set of the first area and the second area satisfies a relationship such that the following (a2) is higher than the following (a1):
(a1) an atomic concentration of carbon atoms contained in the first area; and
(a2) an atomic concentration of carbon atoms contained in the second area.

<2> The thermally conductive sheet described in <1>, wherein a value obtained by dividing the (a2) by the (a1) is not less than 1.01.

<3> The thermally conductive sheet described in <1> or <2>, wherein a difference between the (a2) and the (a1) is not less than 1% by atom.

<4> The thermally conductive sheet described in any of <1> to <3>, wherein the (a2) is measured in one strip among strips constituting the thermally conductive sheet, and the (a1) is measured in an area between the one strip and another strip which is adjacent to the one strip.

<5> The thermally conductive sheet described in any of <1> to <4>, wherein the organic polymer compound (B) is an acrylic ester-based resin having a functional group.

<6> The thermally conductive sheet described in any of <1> to <5>, wherein a content of the graphite particles (A) in the composition is 30% by weight to 80% by weight relative to a total weight of the composition.

<7> A method for producing a thermally conductive sheet, including:
a primary sheet forming step of forming, in sheet form, a mixture containing graphite particles (A), an organic polymer compound (B), and a solvent to obtain a
a laminate forming step of laminating the primary sheet to obtain a primary sheet laminate; and
a slicing step of slicing a laminate cross section of the primary sheet laminate to obtain a thermally conductive sheet.

<8> The method described in <7>, wherein the primary sheet forming step is a step of forming the primary sheet by applying a coating of the mixture.

<9> The method described in <7> or <8>, wherein the primary sheet forming step is a step of forming the primary sheet by applying a coating of the mixture and then carrying out drying.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss an embodiment of the present invention in more detail with reference to Examples and Comparative Example. Note, however, that the present invention is not limited to these examples.

### Evaluation Methods

Evaluation methods in Examples and Comparative Example will be described below.

### <Atomic Concentration of Carbon Atoms and Atomic Concentration of Oxygen Atoms>

An ultra-high-resolution scanning electron microscope (ULTRAplus, manufactured by Carl Zeiss) was used as an SEM, and QUANTAX XFlash 5010 manufactured by Bruker AXS, which was attached to the SEM, was used as an EDX. Conditions of observation by the SEM and conditions of analysis by the EDX were as below.

### <Conditions of Observation by SEM>

Acceleration voltage: 5 kV
Detector: SE2 (chamber-type secondary electron detector)

### <Conditions of Analysis by EDX>

Acceleration voltage: 10 kV (elemental mapping at low magnification), 5 kV (elemental mapping at high magnification and area analysis)
Analysis method: ZAF method

The surfaces of a thermally conductive sheet in accordance with an embodiment of the present invention and a comparative thermally conductive sheet were subjected to elemental mapping to verify the in-plane distribution of elements. Next, the thermally conductive sheet in accordance with an embodiment of the present invention was subjected to area analysis and semi-quantification by the ZAF method. As targets for the area analysis, an area measuring 500 μm×50 μm that includes a region appearing darker than its surroundings (area 1) and an area measuring 500 μm×50 μm that does not include the region appearing darker than its surroundings (area 2) were set in an image observed by the SEM. An atomic concentration of carbon atoms and an atomic concentration of oxygen atoms of the areas 1 and 2 were determined by the ZAF method.

### <Thickness>

A 3 cm square piece was cut out from a thermally conductive sheet and used as an evaluation sample. The thickness in four corner parts and one central part of the evaluation sample was measured with use of a micrometer manufactured by Mitutoyo Corporation, and an average of obtained measurement values was regarded as the thickness of the thermally conductive sheet. Note here that “one central part” refers to the position of an intersection of two diagonal lines when diagonal lines are drawn from the four corner parts to diagonally located measurement sites.

### <Graphite Binding Capacity>

Laminates produced in Examples and Comparative Example were sliced, and the state of each of the sliced laminates was visually observed, and graphite binding capacity of a thermally conductive sheet was evaluated by the following criteria:
A (excellent): a case where the shape of a laminate was maintained, and it was possible to slice the laminate
B (good): a case where a laminate was deformed, but it was possible to slice the laminate
C (poor): a case where it was impossible to maintain the shape of a rectangular parallelepiped immediately after production of a laminate or a case where a laminate produced and then sliced was deformed, and it was impossible to slice the laminate

### <Sulfur Content Percentage>

A sulfur content percentage (% by weight) of a thermally conductive sheet was determined by carrying out elemental analysis with use of a scanning X-ray fluorescence analyzer (ZSX Primus III+, manufactured by Rigaku Holdings Corporation).

The sulfur content percentage of a thermally conductive sheet was evaluated by the following criteria:
A (excellent): not more than 0.10% by weight
B (good): more than 0.10% by weight and not more than 0.30% by weight
C (poor): more than 0.30% by weight

### <Hardness>

A laminate consisting of only a thermally conductive sheet (laminate before slicing) was used as an evaluation sample for hardness of the thermally conductive sheet to evaluate the hardness at a center of a cross section (6.5 cm×6.5 cm) of the laminate. Note that the laminate is, in more detail, a laminate which is obtained by operations described in <Preparation of laminate> (described later) and which has not been subjected to operations described in <Preparation of thermally conductive sheet>. Specifically, hardness at the center of the cross section of the evaluation sample was measured in accordance with the Asker C method of the Society of Rubber Industry, Japan Standard (SRIS) with use of a hardness meter (ASKER CL-150LJ, manufactured by Kobunshi Keiki Co., Ltd.). The hardness at 20 °C is a hardness measured under conditions of 20 °C, and the hardness at 70 °C is a hardness measured under conditions of 70 °C.

The hardness at 20 °C of the thermally conductive sheet was evaluated by the following criteria:
A (excellent): not less than 84
B (good): not less than 80 and less than 84
C (poor): less than 80

The hardness at 70 °C of the thermally conductive sheet was evaluated by the following criteria:
A (excellent): more than 63
B (good): more than 60 and less than 63
C (poor): not more than 60

### <Thermal Resistance Value>

A 1 cm square piece was cut out from a thermally conductive sheet and used as an evaluation sample. For the evaluation sample, a thermal resistance value (cm²K/W) of the thermally conductive sheet was measured with use of a thermal resistance measurement device (resin material thermal resistance measurement device manufactured by Hitachi Technologies and Services, Ltd.) at a sample temperature of 50 °C and at a pressure of 0.5 MPa.

The thermal resistance value of the thermally conductive sheet was evaluated by the following criteria:
A (excellent): a case where the thermal resistance value of the thermally conductive sheet is not more than 0.080 cm²K/W
B (good): a case where the thermal resistance value of the thermally conductive sheet is more than 0.080 cm²K/W and not more than 0.10 cm²K/W
C (poor): a case where the thermal resistance value of the thermally conductive sheet is more than 0.10 cm²K/W

### <Tackiness>

Under conditions of 25 °C, a texture analyzer (product name: TA-XT plus 100 C, manufactured by Eko Instruments Co., Ltd.) was used to measure a numerical value representing tackiness of a thermally conductive sheet to evaluate tackiness of the thermally conductive sheet. Specifically, the tackiness was evaluated with use of a 7-mm-diameter probe under the conditions that test speeds were 0.5 mm/sec (before measurement), 0.1 mm/sec (during measurement), and 10 mm/sec (return), and a force of 40N was applied.

### Tackiness A: Integral Value of Tack Strength

A (excellent): a case where the numerical value representing the tackiness A is more than 3.0 N·mm and less than 5.0 N·mm
B (good): a case where the numerical value representing the tackiness A is more than 0.7 N·mm and not more than 3.0 N·mm
C (poor): a case where the numerical value representing the tackiness A is not more than 0.7 N·mm or not less than 5.0 N·mm

### Tackiness B: Intensity of a Peak Top of Tack Strength

A (excellent): a case where the numerical value representing the tackiness B is more than 9.50 N and less than 16.00 N
B (good): a case where the numerical value representing the tackiness B is more than 1.40 N and not more than 9.50 N
C (poor): a case where the numerical value representing the tackiness B is not more than 1.40 N or not less than 16.00 N

### <30% Compressive Strength>

Under conditions of 23 °C, a 30% compressive strength of a thermally conductive sheet was evaluated with use of a small universal material testing machine (product name: Model 5565, manufactured by Instron). Specifically, a sample size was set to be 15 mm×15 mm×2 mm. An evaluation sample was prepared by stacking thermally conductive sheets each measuring 15 mm×15 mm to a thickness of 2 mm. The evaluation sample was held from above and below by polyimide films each measuring 12.5 μm. The thickness of the polyimide films was subtracted in the analysis. As a measurement method, a crosshead travel method (with device compliance correction) was used, and the 30% compressive strength was evaluated under the conditions that the test speed was 1.0 mm/min.

Criteria for the evaluation of the 30% compressive strength are as follows:
A: (excellent) more than 2.00 MPa
B: (good) more than 1.00 MPa and not more than 2.00 MPa
C: (poor) not more than 1.00 MPa

### <Compressive Elastic Modulus and Compressive Strain at 150 °C>

Under conditions of 150 °C, a compressive elastic modulus at 0.03 MPa, a compressive elastic modulus at 0.10 MPa, and a compressive strain at 0.14 MPa of a thermally conductive sheet were evaluated with use of a universal material testing machine (product name: Model 1185, manufactured by Instron). Specifically, a sample size was set to be 14 mm in diameter. The evaluation sample was held from above and below by polyimide films each measuring 12.5 μm. The thickness of the polyimide films was subtracted in the analysis. As a measurement method, a crosshead travel method (with device compliance correction) was used, and the compressive elastic moduli and the compressive strain were evaluated under the conditions that the test speed was 0.1 mm/min.

Criteria for the evaluation of the compressive elastic modulus at 150 °C and at 0.03 MPa are as follows:
A: (excellent) more than 0.60 and not more than 1.20
B: (good) more than 1.20 and less than 1.65
C: (poor) not more than 0.60 and not less than 1.65

Criteria for the evaluation of the compressive elastic modulus at 150 °C and at 0.10 MPa are as follows:
A: (excellent) more than 1.40 MPa and less than 2.50 MPa
B: (good) not less than 2.50 MPa and less than 3.40 MPa
C: (poor) not more than 1.40 MPa and not less than 3.40 MPa

Criteria for the evaluation of the compressive strain at 150 °C and at 0.14 MPa are as follows:
A: (excellent) more than 11.0% and less than 36.0%
B: (good) more than 5.0% and not more than 11.0
C: (poor) not more than 5.0% and not less than 36.0%

### <Temporary Bonding Property>

A temporary bonding property of a thermally conductive sheet is evaluated by peeling off a thermally conductive sheet having a size of 40 mm×40 mm from a separator and attaching the thermally conductive sheet to a silicon wafer measuring 50 mm×50 mm. Having excellent temporary bonding property means the following:
It is easy to peel off the thermally conductive sheet from the separator.
The thermally conductive sheet can be fixed on the silicon wafer and attached accurately.
The thermally conductive sheet is not detached even when the silicon wafer is transported or reversed.
Air entrained between the silicon wafer and the thermally conductive sheet easily escapes.

Criteria for the evaluation are as follows:
A: (excellent) The thermally conductive sheet is easily peeled off from the separator, is easily attached to the silicon wafer, and is less likely to entrain air.
B: (good) The thermally conductive sheet is easily peeled off from the separator, is easily attached to the silicon wafer (a little lighter), and is less likely to entrain air.
C: (poor) The thermally conductive sheet is peeled off from the separator with difficulty, is excessively attached to the silicon wafer, and entrains air. Or, the thermally conductive sheet is excessively detached from the separator and is not attached to the silicon wafer.

### <Initial Adhesion>

Silicon (50 mm×50 mm×0.7 mm), a thermally conductive sheet (40 mm×40 mm×0.11 mm), and a spreader (nickel-plated copper: 50 mm×50 mm×2 mm) were stacked in this order on a heat press device and set. Subsequently, the heat press device was used to bond the silicon, the thermally conductive sheet, and the spreader in this order under conditions of 150 °C and 100 kg. This resulted in obtainment of an adhesion measurement laminate. Subsequently, a scanning acoustic tomograph (product name: FineSAT, manufactured by Hitachi Power Solutions Co., Ltd.) was used to measure an area of adhesion between the thermally conductive sheet and adherends (the silicon and the spreader) in the adhesion measurement laminate.

Initial adhesion of the thermally conductive sheet was evaluated by the following criteria:
A (excellent): a case where the area of adhesion is not less than 95% of the area of the entire surface on a side of the thermally conductive sheet which side adheres to the adherend
B (good): a case where the area of adhesion is not less than 90% and less than 95% of the area of the entire surface on the side of the thermally conductive sheet which side adheres to the adherend
C (poor): a case where the area of adhesion is less than 90% of the area of the entire surface on the side of the thermally conductive sheet which side adheres to the adherend
   <Adhesion after High Temperature Holding>

An adhesion measurement laminate was obtained by a method identical to the method described in the above <Initial adhesion> section. Subsequently, the adhesion measurement laminate was placed in a heating furnace and then held for 100 hours in a state in which the ambient temperature inside such a heating furnace was heated to 150 °C. Thereafter, the adhesion measurement laminate was removed from the heating furnace, and an area of adhesion between the thermally conductive sheet and the adherends (the silicon and the spreader) in the adhesion measurement laminate was measured. Adhesion after high temperature holding was evaluated on the basis of the area of adhesion by the same criteria as the evaluation criteria for the initial adhesion that are described in the above <Initial adhesion> section.

<Adhesion after Heat Cycle>

Adhesion after a heat cycle was evaluated by a method identical to the method described in the above <Adhesion after high temperature holding> section, except for matters shown below. Note that the adhesion after a heat cycle was evaluated by the same criteria as the evaluation criteria for the initial adhesion that are described in the above <Initial adhesion> section.
An adhesion measurement laminate was placed in a heat shock tester (product name: ES-56L, manufactured by Hitachi Appliances, Ltd.), instead of the heating furnace. Subsequently, a heat cycle was repeated 500 times. In the heat cycle, the ambient temperature inside the heat shock tester was raised to 120 °C, then lowered to −40 °C, and subsequently raised again to 120 °C.

### Example 1

### <Preparation of Composition Solution>

A planetary centrifugal mixer was used to stir and mix materials (shown below) over 10 minutes to obtain a composition solution. The composition solution had a solid content concentration of 30.0% by weight. The composition solution corresponds to the “mixture containing graphite particles (A), an organic polymer compound (B), and a solvent” described in the above-described [2. Method for producing thermally conductive sheet].
As the graphite particles (A), 125.71 g of scale-like graphite powder (average particle size: 73 μm, thickness: 0.80 μm, aspect ratio: 91, sulfur content percentage: not more than 1.0% by weight) was used.
As the acrylic resin including a functional group, 336.76 g of a 15% by weight toluene/ethyl acetate solution containing an acrylic resin (weight average molecular weight: 900,000, Tg: −60 °C, content of a hydroxyl group as the functional group: 0.116 mmol/g, 6.5 KOHmg/g, liquid at normal temperature) (50.51 g as the acrylic resin including a functional group) was used;
As the acrylic block copolymer, 112.76 g of a 15% by weight toluene/ethyl acetate solution containing an acrylic block copolymer (weight average molecular weight: 56,000, Tg: 100 °C to 120 °C for hard segment and −50 °C to −40 °C for soft segment, not including the functional group, liquid at normal temperature) (16.91 g as the acrylic block copolymer not including a functional group) was used;
As a tackifier, 22.86 g of a hydrogenated petroleum resin having a softening point of 90 °C was used.
As a plasticizer, 11.43 g of polybutene having a weight average molecular weight of 3,700 was used.
As an anti-aging agent, 1.14 g of an amine-based anti-aging agent (4,4′-bis(α,α-dimethyl benzyl) diphenylamine) was used.
As toluene, toluene having an amount such that the solid content concentration of the composition solution would be 30.0% by weight was used.

### <Preparation of Primary Sheet>

The resulting composition solution was applied to and spread on a polyethylene terephthalate film, with a clearance provided, so that a coating film would have a thickness of 2 mm, the polyethylene terephthalate film having a mold release treated surface. Thereafter, a resulting sheet was dried at 120 °C for not less than 20 minutes, and the dried sheet was peeled off to obtain a primary sheet having a thickness of 2 mm. This operation was repeated three times to prepare three primary sheets.

The content of the graphite particles, the acrylic ester-based resin, and the anti-aging agent relative to the total weight of the composition contained in the primary sheet corresponds to the content of the graphite particles, the acrylic ester-based resin, and the anti-aging agent relative to the total weight of a composition contained in a thermally conductive sheet that is finally obtained, i.e., the thermally conductive sheet that is finally obtained.

### <Preparation of Laminate>

A 2.4 cm×6.4 cm sheet was cut out from each of the three primary sheets thus obtained. Every time 5 sheets were stacked in a container having an internal volume of 2.5 cm in length×6.5 cm in width×7.5 cm in height, the stacked sheets were pressed at normal temperature and at a pressure of not less than 400 kg, and stacking and pressing were repeated until the pressed sheets had a thickness of not less than 6.5 cm after final pressing. Next, a laminate obtained by stacking the sheets until the thickness reached not less than 6.5 cm was heated at 120 °C for 15 minutes and then pressed at a pressure of not less than 400 kg, so that a laminate of 2.5 cm×6.5 cm×6.5 cm was obtained.

### <Preparation of Thermally Conductive Sheet>

By slicing a laminate cross section of the obtained laminate at an angle of 45 degrees relative to a direction in which the sheets were stacked, produced was a thermally conductive sheet which measured 6.5 cm in length×6.5 cm in width×110 μm in thickness and in which the graphite particles were oriented in a thickness direction of the thermally conductive sheet.

### Examples 2 to 4

A thermally conductive sheet was prepared in the same manner as in Example 1, except that the amounts of the materials used in Example 1 were changed to a mixing ratio shown in Table 1. The film thickness of thermally conductive sheets obtained in Examples 2 and 3 was 110 μm, and the film thickness of a thermally conductive sheet obtained in Example 4 was 75 μm.

### Comparative Example 1

120 g of scale-like expanded graphite powder (average particle size: 250 μm, thickness: 5 μm, aspect ratio: 50, sulfur content percentage: not less than 1.5% by weight) as the graphite particles (A), 54 g of an acrylic ester-based resin (weight average molecular weight: 1,200,000, Tg: −37 °C, containing an OH group as a functional group) as the organic polymer compound (B), and 66 g of aromatic condensed phosphate ester (CR-741, manufactured by Daihachi Chemical Industry Co., Ltd.) were melted and kneaded while being heated.

### <Preparation of Primary Sheet>

A portion of 240 g of the obtained composition was taken, rounded into a massive form, sandwiched between PTFE films, and pressed with use of a press having a tool surface measuring 10 cm×20 cm under the conditions that a tool pressure was 10 MPa and a tool temperature was 170 °C to obtain a primary sheet with a thickness of 3 mm. This operation was repeated to prepare multiple primary sheets.

### <Preparation of Laminate>

A 2.4 cm×6.4 cm sheet was cut out from each of the primary sheets thus obtained. Every time 5 sheets were stacked in a container having an internal volume of 2.5 cm in length×6.5 cm in width×7.5 cm in height, the stacked sheets were pressed at normal temperature and at a pressure of not less than 400 kg, and stacking and pressing were repeated until the pressed sheets had a thickness of not less than 6.5 cm after final pressing. Next, a laminate obtained by stacking the sheets until the thickness reached not less than 6.5 cm was heated at 120 °C for 15 minutes and then pressed at a pressure of not less than 400 kg, so that a laminate of 2.5 cm×6.5 cm×6.5 cm was obtained.

### <Preparation of Comparative Thermally Conductive Sheet>

By slicing a laminate cross section of the obtained laminate at an angle of 45 degrees relative to a direction in which the sheets were stacked, produced was a comparative thermally conductive sheet which measured 6.5 cm in length×6.5 cm in width×250 μm in thickness and in which the graphite particles were oriented in a thickness direction of the comparative thermally conductive sheet.

### [Evaluation of Thermally Conductive Sheet]

Table 1 shows the results obtained by measuring, in accordance with the above-described evaluation methods, physical properties of the thermally conductive sheets obtained in Examples 1 to 4 and the comparative thermally conductive sheet obtained in Comparative Example 1. Note that, in Table 1, the graphite particles (A), the organic polymer compound (B), and the plasticizer used in Examples 1 to 4 are all denoted as “A”. Note also that the graphite particles (A), the organic polymer compound (B), and the plasticizer used in Comparative Example 1 are all denoted as “B”. The “mixing ratio” is a ratio of the solid content weight of the material used to the solid content weight of all of the materials except for the solvent. For example, “55.0”, which is the mixing ratio of the graphite particles in Example 1, indicates that the ratio of the solid content weight of the graphite particles (A) used in Example 1 to the solid content weight of all of the materials used in Example 1 except the solvent is 55.0% by weight.

TABLE 1

| | | | | | Comparative |
|---|---|---|---|---|---|
| | Example 1 | Example 2 | Example 3 | Example 4 | Example 1 |
| Type of graphite particles (A) | A | A | A | A | B |
| Mixing ratio of graphite particles (A) | 55.0 | 52.5 | 50.5 | 50.5 | 50.0 |
| (% by weight) | | | | | |
| Type of acrylic resin | A | A | A | A | B |
| Mixing ratio of acrylic resin | 22.1 | 24.0 | 25.5 | 25.5 | 22.5 |
| (% by weight) | | | | | |
| Mixing ratio of acrylic block | 7.4 | 8.0 | 8.5 | 8.5 | — |
| copolymer (% by weight) | | | | | |
| Mixing ratio of additive (tackifier) | 10.0 | 10.0 | 10.0 | 10.0 | — |
| (% by weight) | | | | | |
| Type of additive (plasticizer) | A | A | A | A | B |
| Mixing ratio of additive (plasticizer) | 5.0 | 5.0 | 5.0 | 5.0 | 27.5 |
| (% by weight) | | | | | |
| Mixing ratio of anti-aging agent | 0.5 | 0.5 | 0.5 | 0.5 | — |
| (% by weight) | | | | | |
| Mixing method for materials | Stirring and | Stirring and | Stirring and | Stirring and | Melting and |
| | mixing with | mixing with | mixing with | mixing with | kneading without |
| | use of solvent | use of solvent | use of solvent | use of solvent | use of solvent |
| Thickness (μm) | 110 | 110 | 110 | 75 | 250 |
| Evaluation of | A | A | A | A | A |
| graphite binding capacity | | | | | |
| Sulfur content percentage | 0.083 | 0.082 | 0.081 | 0.081 | 0.390 |
| (% by weight) | | | | | |
| Evaluation of | A | A | A | A | C |
| sulfur content percentage | | | | | |
| Hardness at 20 °C | ≥84 | ≥84 | ≥84 | ≥84 | <80 |
| Evaluation of hardness at 20 °C | A | A | A | A | C |
| Hardness at 70 °C | >63 | >63 | >63 | >63 | ≤60 |
| Evaluation of hardness at 70 °C | A | A | A | A | C |
| Atomic concentration (a1) of | 88.9 | 91.0 | 92.4 | 92.0 | 91.9 |
| carbon atoms in area 1 | | | | | |
| (% by atom) | | | | | |
| Atomic concentration of oxygen | 11.1 | 9.0 | 7.6 | 8.0 | 8.1 |
| atoms in area 1 (% by atom) | | | | | |
| Atomic concentration (a2) of | 95.7 | 96.5 | 96.6 | 97.0 | 91.9 |
| carbon atoms in area 2 | | | | | |
| (% by atom) | | | | | |
| Atomic concentration of oxygen | 4.3 | 3.5 | 3.4 | 3.0 | 8.1 |
| atoms in area 2 (% by atom) | | | | | |
| (a2)/(a1) | 1.08 | 1.06 | 1.05 | 1.05 | 1.00 |
| (a2) − (a1) | 6.8 | 5.5 | 4.2 | 5.0 | 0.0 |
| Thermal resistance value (cm²K/W) | <0.082 | <0.082 | <0.082 | <0.082 | >0.13 |
| Evaluation of | A | A | A | A | C |
| thermal resistance value | | | | | |
| Tackiness A (N · mm) | 3.0 | 3.6 | 4.5 | 4.1 | 5.1 |
| Evaluation of tackiness A (N · mm) | B | A | A | A | C |
| Tackiness B (N) | 9.5 | 11.3 | 13.9 | 12.5 | 16.0 |
| Evaluation of tackiness B (N) | B | A | A | A | C |
| 30% compressive strength | 2.01 | 2.07 | 2.10 | 2.05 | 0.98 |
| (MPa) | | | | | |
| Evaluation of | A | A | A | A | C |
| 30% compressive strength | | | | | |
| Compressive elastic modulus | 1.20 | 1.09 | 0.99 | 0.81 | 1.65 |
| at 150 °C and at 0.03 MPa (MPa) | | | | | |
| Evaluation of compressive elastic | A | A | A | A | C |
| modulus at 150 °C and at 0.03 MPa | | | | | |
| Compressive elastic modulus | 2.50 | 2.31 | 2.14 | 1.58 | 3.42 |
| at 150 °C and at 0.10 MPa (MPa) | | | | | |
| Evaluation of compressive elastic | A | A | A | A | C |
| modulus at 150 °C and at 0.10 MPa | | | | | |
| Compressive strain | 11.0 | 12.2 | 14.0 | 23.3 | 36.0 |
| at 150 °C and at 0.14 MPa (%) | | | | | |
| Evaluation of compressive strain | A | A | A | A | C |
| at 150 °C and at 0.14 MPa | | | | | |
| Evaluation of | A | A | A | A | C |
| temporary bonding property | | | | | |
| Evaluation of initial adhesion | A | A | A | A | C |
| Evaluation of adhesion after high | A | A | A | A | C |
| temperature holding | | | | | |
| Evaluation of | A | A | A | A | C |
| adhesion after heat cycle | | | | | |

As shown in Table 1, the thermally conductive sheets described in Examples 1 to 4 each had a lower thermal resistance value than the thermally conductive sheet in Comparison Example 1 and were vastly superior. In addition, the thermally conductive sheets described in Examples 1 to 4 were also superior to Comparative Example 1 in tackiness A, tackiness B, temporary bonding property, initial adhesion, adhesion after high temperature holding, and adhesion after a heat cycle. Further, the thermally conductive sheets described in Examples 1 to 4 were also superior to Comparative Example 1 in graphite binding capacity, sulfur content percentage, hardness at 20 °C, hardness at 70 °C, 30% compressive strength, compressive elastic modulus, and compressive strain.

The results shown in Table 1 revealed that the thermally conductive sheet in accordance with an embodiment of the present invention had a low thermal resistance value, excellent tackiness, excellent initial adhesion, excellent adhesion after high temperature holding, and excellent adhesion after a heat cycle. In addition, it was revealed that the thermally conductive sheet in accordance with an embodiment of the present invention also had excellent properties in terms of graphite binding capacity, sulfur content percentage, hardness, compressive strength, compressive elastic modulus, and compressive strain.

FIG. 1 is a view showing the results obtained by subjecting a surface of the thermally conductive sheet obtained in Example 1 to SEM-EDX and mapping. 1001 indicates the result of identification of carbon, and 1002 is an SEM image of the surface. Note that, in addition to identification of carbon, identifications of nitrogen, oxygen, and silicon were also made, but are not shown in the drawings.

FIG. 2 is an enlarged view of 1002 in FIG. 1 and is a view showing states of an area measuring 500 μm×50 μm (area 1) and an area measuring 500 μm×50 μm (area 2) which are set on the surface of the thermally conductive sheet.

FIG. 3 is a view showing the results obtained by subjecting a surface of the thermally conductive sheet obtained in Example 3 to SEM-EDX and mapping. 1003 indicates the result of identification of carbon, and 1004 is an SEM image of the surface. Note that, in addition to identification of carbon, identifications of nitrogen, oxygen, and silicon were also made, but are not shown in the drawings.

FIG. 4 is an enlarged view of 1004 in FIG. 3 and is a view showing states of an area measuring 500 μm×50 μm (area 1) and an area measuring 500 μm×50 μm (area 2) which are set on the surface of the thermally conductive sheet.

As shown in 1001 and 1002 in FIG. 1 and in 1003 and 1004 in FIG. 3, in the thermally conductive sheets obtained in Examples 1 and 3, regions appearing darker than their surroundings and being spaced at substantially equal intervals were clearly observed. Note that the thermally conductive sheets obtained in Examples 2 and 4 were also subjected to mapping similar to the mapping in FIGS. 1 and 3, and similar results were obtained, but are not shown in the drawings.

Meanwhile, FIG. 5 is a view showing the results obtained by subjecting a surface of the thermally conductive sheet in accordance with Comparative Example 1 to SEM-EDX and mapping. 1005 indicates the result of identification of carbon, and 1006 is an SEM image of the surface. Note that, in addition to identification of carbon, identifications of nitrogen, oxygen, and silicon were also made, but are not shown in the drawings.

FIG. 6 is an enlarged view of 1006 in FIG. 5 and shows states of areas 1 and 2 which are set respectively at positions substantially corresponding to the areas 1 and 2 shown in FIG. 2.

As shown in FIGS. 5 and 6, in the thermally conductive sheet in accordance with Comparative Example 1, a region appearing darker than its surrounding was not observed.

As shown in Table 1, in the thermally conductive sheets in Examples 1 to 4, the atomic concentration of carbon atoms in the area 1 was lower than that in the area 2, and the atomic concentration of oxygen atoms in the area 1 was higher than that in the area 2. That is, significant compositional differences between the area 1 and the area 2 were found. On the other hand, as shown in Table 1, in the thermally conductive sheet of Comparative Example 1, no compositional difference between the area 1 and the area 2 was found.

The fact, shown in Table 1, that (a2) is higher than (a1) corresponds to the fact that the physical properties of the thermally conductive sheets obtained in Examples 1 to 4 are more excellent than those of the thermally conductive sheet obtained in Comparative Example 1. The same is true for the fact that (a2)/(a1) is not less than 1.01 and for the fact that (a2)−(a1) is not less than 1% by atom. Thus, it is considered that the thermally conductive sheet of an aspect of the present invention exhibits excellent physical properties by having the area 1 and the area 2 and having a compositional difference in that there are differences between the area 1 and the area 2 in the atomic concentration of carbon atoms and the atomic concentration of oxygen atoms.

### INDUSTRIAL APPLICABILITY

An embodiment of the present invention is preferably applicable to production of a thermally conductive sheet that has a low thermal resistance value, excellent tackiness, excellent initial adhesion, excellent adhesion after high temperature holding, and excellent adhesion after a heat cycle. Further, an embodiment of the present invention is preferably applicable to production of a product in which the thermally conductive sheet is used, e.g., an electronic component that includes a wiring board, a semiconductor package, and the like.

1. A thermally conductive sheet comprising a composition containing graphite particles (A) and an organic polymer compound (B),
the graphite particles (A) being oriented in a thickness direction of the thermally conductive sheet, wherein
when a first area measuring 500 μm×50 μm and a second area measuring 500 μm×50 μm are set on a surface of the thermally conductive sheet,
at least one set of the first area and the second area satisfies a relationship such that the following (a2) is higher than the following (a1):
(a1) an atomic concentration of carbon atoms contained in the first area; and
(a2) an atomic concentration of carbon atoms contained in the second area.

2. The thermally conductive sheet according to claim 1, wherein a value obtained by dividing the (a2) by the (a1) is not less than 1.01.

3. The thermally conductive sheet according to claim 1, wherein a difference between the (a2) and the (a1) is not less than 1% by atom.

4. The thermally conductive sheet according to claim 1, wherein the (a2) is measured in one strip among strips constituting the thermally conductive sheet, and the (a1) is measured in an area between the one strip and another strip which is adjacent to the one strip.

5. The thermally conductive sheet according to claim 1, wherein the organic polymer compound (B) is an acrylic ester-based resin having a functional group.

6. The thermally conductive sheet according to claim 1, wherein a content of the graphite particles (A) in the composition is 30% by weight to 80% by weight relative to a total weight of the composition.

7. A method for producing a thermally conductive sheet, comprising:
a primary sheet forming step of forming, in sheet form, a mixture containing graphite particles (A), an organic polymer compound (B), and a solvent to obtain a primary sheet;
a laminate forming step of laminating the primary sheet to obtain a primary sheet laminate; and
a slicing step of slicing a laminate cross section of the primary sheet laminate to obtain a thermally conductive sheet.

8. The method according to claim 7, wherein the primary sheet forming step is a step of forming the primary sheet by applying a coating of the mixture.

9. The method according to claim 7, wherein the primary sheet forming step is a step of forming the primary sheet by applying a coating of the mixture and then carrying out drying.
